(19) United States
(12) Patent Application Publication
(10) Pub. No.: US 2003/0043920 A1
(43) Pub. Date: Mar. 6, 2003

(54) Image processing method

(76) Inventors: Kozo Akiyoshi, Tokyo (JP); Nobuo Akiyoshi, Tokyo (JP)

Correspondence Address: Dowell & Dowell, P.C., Suite 309, 1215 Jefferson Davis Highway, Arlington, VA, 22202, US

(21) Appl. No.: 10/140,827

(22) Filed: May 9, 2002

(30) Foreign Application Priority Data
May 9, 2001 (JP) 2001-138164
Jul. 17, 2001 (JP) 2001-216243

(51) Int. Cl. H04N 7/12

(52) U.S. Cl. 375/240.25; 382/100; 382/233; 380/223

(57) ABSTRACT

A method and apparatus for image processing in which data for image processing are imprinted into the images to be processed. An image input unit receives a first image and a second image for encoding. A matching processor performs a pixel-by-pixel matching between the images and transmits a corresponding point file to an imprinting unit. The corresponding point file and a program for processing the images and the corresponding point file are imprinted into the first image and an altered first image is generated. In decoding, an extracting unit extracts the corresponding point file from the altered first image and an intermediate image generator utilizes the program to generate intermediate images from the first image, the second image and the corresponding point file.

### BACKGROUND OF THE INVENTION

1. Field of the Invention

The present invention relates to image processing techniques, and more particularly relates to techniques of encoding and decoding images for transmission or storage.

2. Description of the Related Art

Recently, image processing and compression methods such as those proposed by MPEG (Motion Picture Expert Group) have expanded to be used with transmission media such as network and broadcast rather than just storage media such as CDs. Generally speaking, the success of the digitization of broadcast materials has been caused at least in part by the availability of MPEG compression coding technology. In this way, a barrier that previously existed between broadcast and other types of communication has begun to disappear, leading to a diversification of service-providing businesses. Thus, we are facing a situation where it is hard to predict how the digital culture would evolve in this age of broadband.

Even in such a chaotic situation, it is clear that the direction of the compression technology of motion pictures will be to move to both higher compression rates and better image quality. It is a well-known fact that block distortion in MPEG compression is sometimes responsible for causing degraded image quality and preventing the compression rate from being improved.

### SUMMARY OF THE INVENTION

The present invention has been developed in view of the above situation and is intended to provide encoding and decoding techniques for the efficient compression of image data. Another object of the present invention is to provide encoding and decoding techniques to attempt to meet two opposite requests: (1) to keep good quality of images and (2) to achieve a higher rate of compression.

An embodiment of the present invention relates to an image processing technology. This technology may utilize the image matching technology (hereinafter referred to as the “base technology”) which was proposed in Japanese patent No.2927350, U.S. Pat. No. 6,018,592 and U.S. Pat. No. 6,137,910 assigned to the same assignee.

An image processing method according to an embodiment of the present invention comprises: acquiring images; and imprinting data utilized for processing the images into the images. In a particular case, the “data utilized for processing” may be data that is used for decoding the images when the images are initially encoded. In this case, the present invention can be considered as an image encoding technology. In another particular case, the “data utilized for processing” may be data which instructs a processing of the images, such as, for example, “Display the images after decompression”. Still another particular case involves data or parameters that are used for image processing. For example, the parameters may be parallax data of each point or each pixel on the images such that a pseudo three-dimensional image of the images can be displayed based on the data.

Various known technologies describe imprinting copyright information on an image as a watermark in a visible or invisible manner, however, in these techniques, the information or data imprinted is not used for the processing which is performed on the image. According to this embodiment of the present invention, desired processing can be included with and performed on the images because data regarding the image processing is imprinted. The security of the data is enhanced in distributing or reproducing the images because the processing data or content can be concealed easily if the data are imprinted in an “invisible” manner. Further, in many cases, a reproducing device which does not know the existence of the data can reproduce at least a part of the images because the image frames themselves are distributed. Backward compatibility is, therefore, sufficiently provided.

Another embodiment of the present invention comprises: acquiring a first image and a second image; computing a matching between the acquired first and second images; and imprinting the information of corresponding points acquired as a result of the matching into at least one of the first and second images. The information may be imprinted into only one of the first and second images, may be imprinted into both of the images separately, or may be distributed between the two images. Further, the information of the corresponding points between the first image and the second image may be imprinted into the first image and the information of corresponding points between the second image and a third image may be imprinted into the second image and generally the information of corresponding points between an n-th image and an n+1-th image may be imprinted into the n-th image. Besides this, the information of corresponding points between any combination of the images may be imprinted into any image, and it is especially expedient that the information is imprinted into a data structure that is closed as a motion picture when the images form a motion picture stream.

Another embodiment of the present invention relates to an image processing apparatus. This apparatus comprises an image input unit which acquires images and an imprinting unit which imprints data utilized for the processing which is performed on the acquired images, decoding for example, into the images. Still another embodiment comprises an image input unit which acquires a first image and a second image, a matching processor which computes a matching between the acquired first and second images, and an imprinting unit which imprints the information of the corresponding points acquired as a result of the matching into at least one of the first and second images, or imprints into the motion picture stream which comprises those images.

In particular, the matching processor may detect points on the second image which correspond to lattice points of a mesh set on the first image and a destination polygon which corresponds to a source polygon that constitutes the mesh on the first image may be defined on the second image based on the result of detection.

Matching methods utilizing critical points may be an application of the base technology. The base technology, however, does not touch on processing regarding the lattice points or the polygons determined thereby. The introduction (below) of a technique making use of a mesh and polygons makes possible a significant reduction in the size of a file which describes correspondence relation of points between the first image and the second image (herein referred to as a “corresponding point file”).

Namely, in a case where the first and second images have n×m pixels respectively, there are (n×m)² combinations if pixel-by-pixel correspondence is described as is, such that the size of the corresponding point file may become extremely large. However, instead, this correspondence is modified by describing the correspondence relation between the lattice points or, substantially equivalently, the correspondence relation between polygons determined by the lattice points, so that the data amount is reduced significantly. Motion pictures can be reproduced by having only a first image (key frame) or a second image (key frame) and the corresponding point file, with intermediate images (frames) between the first and second images (key frames) discarded, and this method realizes efficient transmission or storing of motion pictures.

Still another embodiment of the present invention relates to a method utilized in reproducing the images. The method comprises: acquiring the images; and extracting data utilized for the processing which is performed on the images, such as decoding for example, from the images. This method may further comprise: performing the interpolation of the images based on the data; and outputting, for example storing, transmitting or displaying, the motion pictures acquired as the result of the interpolation. This embodiment can be, therefore, considered as an image decoding method.

Yet another embodiment of the present invention relates to an apparatus utilized in reproducing images. This apparatus comprises an image input unit which acquires the images, and an extracting unit which extracts the data from the images which is utilized for the processing performed on the images. The apparatus may further comprise an intermediate image generator which performs the interpolation of the images based on the extracted data, and an output unit which outputs the motion pictures acquired as the result of the interpolation.

Yet another embodiment of the present invention relates to an image processing method and it particularly relates to an image encoding method. This method may comprise: acquiring a first image and a second image as key frames, which are respectively a predetermined distance from each other; computing a matching between the acquired first and second images; compressing the first and second images in an intraframe format; imprinting the information of the corresponding points acquired as the result of the matching into a predetermined image in the motion picture stream which comprises the compressed first and second images; generating a coded motion picture stream which comprises at least the first and second images and the predetermined image as the key frames after imprinting; and outputting the coded motion picture stream which is generated.

In this case, as another embodiment, the information or data of the corresponding points acquired as the result of the matching may be imprinted into at least one of the first image and the second image in imprinting the information into the predetermined image in the motion picture stream, and only the compressed first and second images may be comprised in the motion picture stream as the key frames in generating the coded motion picture stream.

In the present description the phrase “compressing in an intraframe format” is intended to mean compressing an image in such a format that decompression processing can be performed by referring solely within the image frame. Various formats of this type are know, for example, the compression of still pictures using the JPEG (joint photographic experts group) format.

An image decoding method according to this embodiment may comprise: decompressing the first and the second images and so forth in the intraframe format after acquiring those images; extracting the information or data of the corresponding points from the first image or the second image or the like into which the information or data has been imprinted; generating intermediate images from the information or data of the corresponding points and the first and second images, which are the key frames, by computing interpolation; and outputting, for example storing or displaying, the generated intermediate images and the first and second images in order.

Another embodiment of the image processing method according to the present invention comprises: acquiring the images; imprinting data utilized for performing the processing on the images (hereinafter referred to as “target data”) into the images; and distributing an electronic key to a user for extracting the target data. Here, the user is generally a user who acquires the images after the imprinting. The “electronic key” may be an appropriate electronic or digital key as is known or becomes known in the art. In particular, the key may be substantially comprised of data or a program and may, for example, comprise the following various elements and combinations thereof and is utilized at a decoding side:

1) A key which decodes the target data when the data are encoded.

2) A key which extracts the target data by performing a processing reverse to the imprinting process of the data.

3) A key which authenticates the user.

4) A key which decodes the entire images when the images including the target data are encoded.

The information or data of the corresponding points is illustrated as just one example of the target data. These variations and other variations regarding the key are also effective throughout this specification.

Yet another embodiment of the present invention relates to an image processing method. This method comprises: acquiring the images; and imprinting a program for reproducing or decoding the images into the images. For “reproducing”, for example, the program may be a so-called viewer or an image player. For “decoding”, for example, an image processing program may be provided which converts discrete image frames into continuous motion pictures by interpolation or other processing when the images comprise discrete image frames. Processing which generates intermediate frames between key frames based on the information of corresponding points between the key frames can be considered as an example of this type of processing and is described in the “base technology” below.

Yet another embodiment of the present invention further relates to an image processing method. This method comprises: acquiring first and the second images; computing a matching between the acquired first and second images; imprinting information of corresponding points acquired as the result of the matching into at least one of the first and second images; and imprinting a program into at least one of the first and second images, which is utilized for generating an intermediate image of the first and second images based on the imprinted information of the corresponding points. In “imprinting”, it is useful to note that the information of the corresponding points may be imprinted into any image included in a motion picture stream which comprises the first and the second images.

Yet another embodiment of the present invention relates to an image processing method. This method is mainly utilized in decoding and comprises: acquiring images; and extracting a program for reproducing or decoding the images, which is imprinted into the acquired images. The method may further comprise: 1) acquiring an electronic key for extracting the program from the images; 2) extracting information of corresponding points imprinted into the images in addition to the program; 3) generating motion pictures based on the images by executing the program; and so forth.

Yet another embodiment of the present invention further relates to an image processing method. This method comprises: acquiring first and second images as the key frames, which respectively keep a predetermined distance between each other; computing a matching between the acquired first and second images; compressing the first and second images in an intraframe format; imprinting a program into at least one of the compressed first and second images, which generates intermediate images of the first and the second images utilizing the result of the matching; generating a coded motion picture stream which includes at least the compressed first and second images as the key frames; and outputting the coded motion picture stream which is generated. The program may be imprinted into a predetermined image in the motion picture stream which comprises the compressed first and second images.

Yet another embodiment of the present invention relates to a content storing method. This method comprises: acquiring a digital content; and imprinting a program for reproducing or decoding the content into the content. In particular, the content may have particularity in relation to the program in that the entire content can be reproduced by utilizing the program, even though the content is stored in a generalized format in which the content can be partly reproduced without the program. Alternatively, the content may also have particularity in relation to the program in that the content can be reproduced with high quality utilizing the program, even though the content is stored in a generalized format in which the content can be reproduced with low quality without the program.

It is to be noted that the base technology is not a requirement of the present invention. Further it is also possible to have replacement or substitution of the above-described structural components and elements of methods in part or whole as between method and apparatus or to add elements to either method or apparatus and also, the apparatuses and methods may be implemented by a computer program and saved on a recording medium or the like and are all effective as and encompassed by the present invention.

Moreover, this summary of the invention includes features that may not be necessary features such that an embodiment of the present invention may also be a sub-combination of these described features.

### BRIEF DESCRIPTION OF THE DRAWINGS

FIG. 1(a) is an image obtained as a result of the application of an averaging filter to a human facial image.

FIG. 1(b) is an image obtained as a result of the application of an averaging filter to another human facial image.

FIG. 1(c) is an image of a human face at p^{(5,0)} obtained in a preferred embodiment in the base technology.

FIG. 1(d) is another image of a human face at p^{(5,0)} obtained in a preferred embodiment in the base technology.

FIG. 1(e) is an image of a human face at p^{(5,1)} obtained in a preferred embodiment in the base technology.

FIG. 1(f) is another image of a human face at p^{(5,1)} obtained in a preferred embodiment in the base technology.

FIG. 1(g) is an image of a human face at p^{(5,2)} obtained in a preferred embodiment in the base technology.

FIG. 1(h) is another image of a human face at p^{(5,2)} obtained in a preferred embodiment in the base technology.

FIG. 1(i) is an image of a human face at p^{(5,3)} obtained in a preferred embodiment in the base technology.

FIG. 1(j) is another image of a human face at p^{(5,3)} obtained in a preferred embodiment in the base technology.

FIG. 2(R) shows an original quadrilateral.

FIG. 2(A) shows an inherited quadrilateral.

FIG. 2(B) shows an inherited quadrilateral.

FIG. 2(C) shows an inherited quadrilateral.

FIG. 2(D) shows an inherited quadrilateral.

FIG. 2(E) shows an inherited quadrilateral.

FIG. 3 is a diagram showing the relationship between a source image and a destination image and that between the m-th level and the (m−1)th level, using a quadrilateral.

FIG. 4 shows the relationship between a parameters η (represented by x-axis) and energy C_{f} (represented by y-axis)

FIG. 5(a) is a diagram illustrating determination of whether or not the mapping for a certain point satisfies the bijectivity condition through the outer product computation.

FIG. 5(b) is a diagram illustrating determination of whether or not the mapping for a certain point satisfies the bijectivity condition through the outer product computation.

FIG. 6 is a flowchart of the entire procedure of a preferred embodiment in the base technology.

FIG. 7 is a flowchart showing the details of the process at S1 in FIG. 6.

FIG. 8 is a flowchart showing the details of the process at S10 in FIG. 7.

FIG. 9 is a diagram showing correspondence between partial images of the m-th and (m−1)th levels of resolution.

FIG. 10 is a diagram showing source images generated in the embodiment in the base technology.

FIG. 11 is a flowchart of a preparation procedure for S2 in FIG. 6.

FIG. 12 is a flowchart showing the details of the process at S2 in FIG. 6.

FIG. 13 is a diagram showing the way a submapping is determined at the 0-th level.

FIG. 14 is a diagram showing the way a submapping is determined at the first level.

FIG. 15 is a flowchart showing the details of the process at S21 in FIG. 6.

FIG. 16 is a graph showing the behavior of energy C_{f}^{(m,s)} corresponding to f^{(m,s)}(λ=iΔλ) which has been obtained for a certain f^{(m,s)} while changing λ.

FIG. 17 is a diagram showing the behavior of energy C_{f}⁽ⁿ⁾ corresponding to f⁽ⁿ⁾(η=iΔη)(i=0,1, . . . ) which has been obtained while changing η.

FIG. 18 shows how pixels correspond between a first image and a second image.

FIG. 19 shows a correspondence relation between a source polygon taken on the first image and a destination polygon taken on the second image.

FIG. 20 shows a procedure by which to obtain the points in the destination polygon corresponding to the points in the source polygon.

FIG. 21 is a flowchart of a procedure for generating and imprinting a corresponding point file according to an embodiment of the present invention.

FIG. 22 is a flowchart showing a procedure for generating an intermediate image by extracting the corresponding point file according to an embodiment of the present invention.

FIG. 23 shows a functional block structure of an image processing apparatus according to an embodiment of the present invention.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

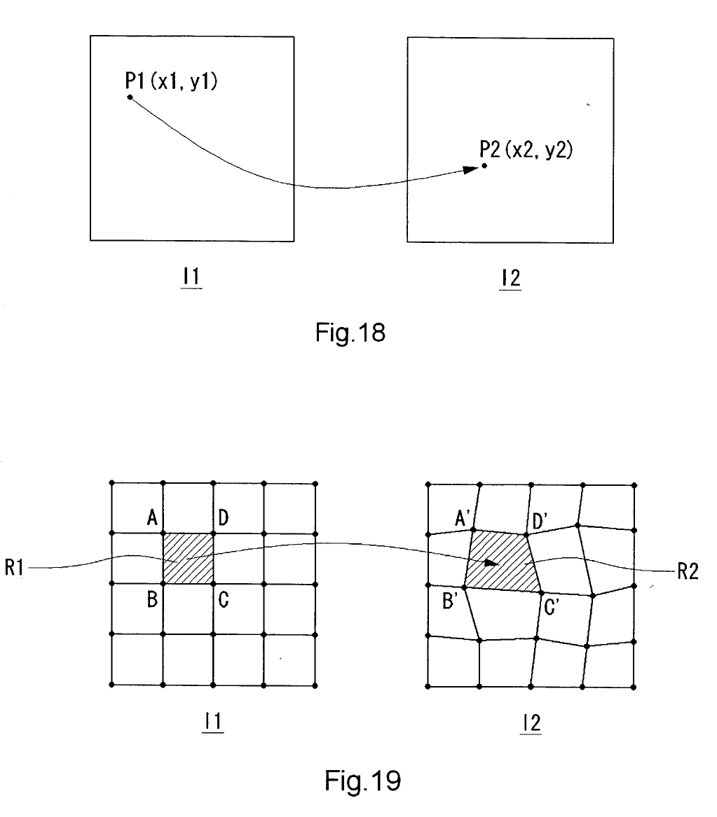

First, the multiresolutional critical point filter technology and the image matching processing using the technology, both of which will be utilized in the preferred embodiments, will be described in detail as “Base Technology”. Namely, the following sections [1] and [2] (below) belong to the base technology, where section [1] describes elemental techniques and section [2] describes a processing procedure. These techniques are patented under Japanese Patent No. 2927350 and owned by the same assignee of the present invention. However, it is to be noted that the image matching techniques provided in the present embodiments are not limited to the same levels. In particular, in FIGS. 18 to 25, image data coding and decoding techniques, utilizing, in part, the base technology, will be described in more detail.

Base Technology

[1] Detailed Description of Elemental Techniques

[1.1] Introduction

Using a set of new multiresolutional filters called critical point filters, image matching is accurately computed. There is no need for any prior knowledge concerning the content of the images or objects in question. The matching of the images is computed at each resolution while proceeding through the resolution hierarchy. The resolution hierarchy proceeds from a coarse level to a fine level. Parameters necessary for the computation are set completely automatically by dynamical computation analogous to human visual systems. Thus, There is no need to manually specify the correspondence of points between the images.

The base technology can be applied to, for instance, completely automated morphing, object recognition, stereo photogrammetry, volume rendering, and smooth generation of motion images from a small number of frames. When applied to morphing, given images can be automatically transformed. When applied to volume rendering, intermediate images between cross sections can be accurately reconstructed, even when a distance between cross sections is rather large and the cross sections vary widely in shape.

[1.2] The Hierarchy of the Critical Point Filters

The multiresolutional filters according to the base technology preserve the intensity and location of each critical point included in the images while reducing the resolution. Initially, let the width of an image to be examined be N and the height of the image be M. For simplicity, assume that N=M=2n where n is a positive integer. An interval [0, N]⊂R is denoted by I. A pixel of the image at position (i, j) is denoted by p^{(i,j)} where i,j∈I.

Here, a multiresolutional hierarchy is introduced. Hierarchized image groups are produced by a multiresolutional filter. The multiresolutional filter carries out a two dimensional search on an original image and detects critical points therefrom. The multiresolutinal filter then extracts the critical points from the original image to construct another image having a lower resolution. Here, the size of each of the respective images of the m-th level is denoted as 2^{m}×2^{m}(0≦m≦n). A critical point filter constructs the following four new hierarchical images recursively, in the direction descending from n.

$${p}_{( i , j )}^{( m , 0 )} = min ( min ( {p}_{( 2 i , 2 j )}^{( m + 1 , 0 )} , {p}_{( 2 i , 2 j + 1 )}^{( m + 1 , 0 )} ) , min ( {p}_{( 2 i + 1 , 2 j )}^{( m + 1 , 0 )} , {p}_{( 2 i + 1 , 2 j + 1 )}^{( m + 1 , 0 )} ) ) \\ {p}_{( i , j )}^{( m , 1 )} = max ( min ( {p}_{( 2 i , 2 j )}^{( m + 1 , 1 )} , {p}_{( 2 i , 2 j + 1 )}^{( m + 1 , 1 )} ) , min ( {p}_{( 2 i + 1 , 2 j )}^{( m + 1 , 1 )} , {p}_{( 2 i + 1 , 2 j + 1 )}^{( m + 1 , 1 )} ) ) \\ {p}_{( i , j )}^{( m , 2 )} = min ( max ( {p}_{( 2 i , 2 j )}^{( m + 1 , 2 )} , {p}_{( 2 i , 2 j + 1 )}^{( m + 1 , 2 )} ) , max ( {p}_{( 2 i + 1 , 2 j )}^{( m + 1 , 2 )} , {p}_{( 2 i + 1 , 2 j + 1 )}^{( m + 1 , 2 )} ) ) \\ {p}_{( i , j )}^{( m , 3 )} = max ( max ( {p}_{( 2 i , 2 j )}^{( m + 1 , 3 )} , {p}_{( 2 i , 2 j + 1 )}^{( m + 1 , 3 )} ) , max ( {p}_{( 2 i + 1 , 2 j )}^{( m + 1 , 3 )} , {p}_{( 2 i + 1 , 2 j + 1 )}^{( m + 1 , 3 )} ) ) \qquad ( 1 )$$

where we let

$${p}_{( i , j )}^{( n , 0 )} = {p}_{( i , j )}^{( n , 1 )} = {p}_{( i , j )}^{( n , 2 )} = {p}_{( i , j )}^{( n , 3 )} = {p}_{( i , j )} \qquad ( 2 )$$

The above four images are referred to as subimages hereinafter. When min_{x≦t≦x+1} and max_{x≦t≦x+1} are abbreviated to a and β, respectively, the subimages can be expressed as follows:

$${P}^{( m , 0 )} = α ( x ) α ( y ) {p}^{( m + 1 , 0 )}$$

$${P}^{( m , 1 )} = α ( x ) β ( y ) {p}^{( m + 1 , 1 )}$$

$${P}^{( m , 2 )} = β ( x ) α ( y ) {p}^{( m + 1 , 2 )}$$

$${P}^{( m , 2 )} = β ( x ) β ( y ) {p}^{( m + 1 , 3 )}$$

Namely, they can be considered analogous to the tensor products of α and β. The subimages correspond to the respective critical points. As is apparent from the above equations, the critical point filter detects a critical point of the original image for every block consisting of 2×2 pixels. In this detection, a point having a maximum pixel value and a point having a minimum pixel value are searched with respect to two directions, namely, vertical and horizontal directions, in each block. Although pixel intensity is used as a pixel value in this base technology, various other values relating to the image may be used. A pixel having the maximum pixel values for the two directions, one having minimum pixel values for the two directions, and one having a minimum pixel value for one direction and a maximum pixel value for the other direction are detected as a local maximum point, a local minimum point, and a saddle point, respectively.

By using the critical point filter, an image (1 pixel here) of a critical point detected inside each of the respective blocks serves to represent its block image (4 pixels here) in the next lower resolution level. Thus, the resolution of the image is reduced. From a singularity theoretical point of view, α(x)α(y) preserves the local minimum point (minima point), β(x)β(y) preserves the local maximum point (maxima point), α(x)β(y) and β(x)α(y) preserve the saddle points.

At the beginning, a critical point filtering process is applied separately to a source image and a destination image which are to be matching-computed. Thus, a series of image groups, namely, source hierarchical images and destination hierarchical images are generated. Four source hierarchical images and four destination hierarchical images are generated corresponding to the types of the critical points.

Thereafter, the source hierarchical images and the destination hierarchical images are matched in a series of resolution levels. First, the minima points are matched using p^{(m,0)}. Next, the first saddle points are matched using p^{(m,1)} based on the previous matching result for the minima points. The second saddle points are matched using p^{(m,2)}. Finally, the maxima points are matched using p^{(m,3)}.

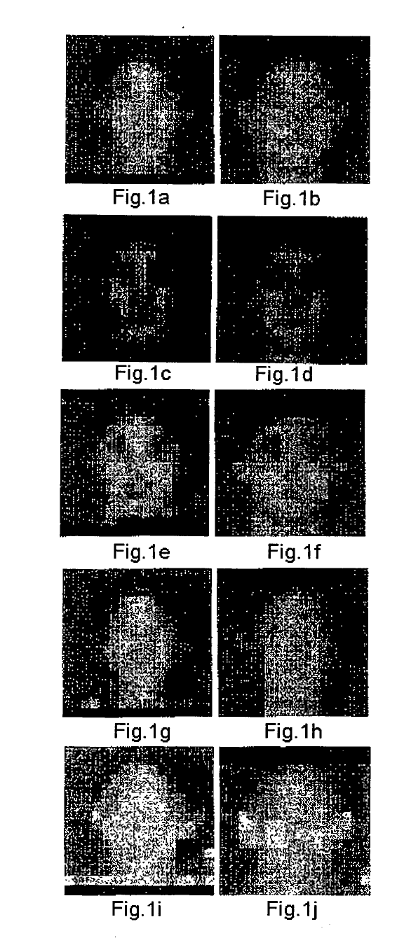

FIGS. 1c and 1d show the subimages p^{(5,0)} of the images in FIGS. 1a and 1b, respectively. Similarly, FIGS. 1e and 1f show the subimages p^{(5,1)}, FIGS. 1g and 1h show the subimages p^{(5,2)}, and FIGS. 1i and 1j show the subimages p^{(5,3)}. Characteristic parts in the images can be easily matched using subimages. The eyes can be matched by p^{(5,0)} since the eyes are the minima points of pixel intensity in a face. The mouths can be matched by p^{(5,1)} since the mouths have low intensity in the horizontal direction. Vertical lines on both sides of the necks become clear by p^{(5,2)}. The ears and bright parts of the cheeks become clear by p^{(5,3)} since these are the maxima points of pixel intensity.

As described above, the characteristics of an image can be extracted by the critical point filter. Thus, by comparing, for example, the characteristics of an image shot by a camera with the characteristics of several objects recorded in advance, an object shot by the camera can be identified.

[1.3] Computation of Mapping Between Images

Now, for matching images, a pixel of the source image at the location (i,j) is denoted by p_{(i,j)}⁽ⁿ⁾ and that of the destination image at (k,l) is denoted by q_{(k,l)}⁽ⁿ⁾ where i, j, k, l∈I. The energy of the mapping between the images (described later in more detail) is then defined. This energy is determined by the difference in the intensity of the pixel of the source image and its corresponding pixel of the destination image and the smoothness of the mapping. First, the mapping f^{(m,0)}:p^{(m,0)}→q^{(m,0)} between p^{(m,0)} and q^{(m,0)} with the minimum energy is computed. Based on f^{(m,0)}, the mapping f^{(m,1)} between p^{(m,1)} and q^{(m,1)} with the minimum energy is computed. This process continues until f^{(m,3)} between p^{(m,3)} and q^{(m,3)} is computed. Each f^{(m,i)}(i=0,1,2, . . . ) is referred to as a submapping. The order of i will be rearranged as shown in the following equation (3) in computing f^{(m,i)} for reasons to be described later.

$${f}^{( m , i )} : {p}^{( m , σ ( i ) )} \to {q}^{( m , σ ( i ) )} \qquad ( 3 )$$

where σ(i)∈{0,1,2,3}.

[1.3.1] Bijectivity

When the matching between a source image and a destination image is expressed by means of a mapping, that mapping shall satisfy the Bijectivity Conditions (BC) between the two images (note that a one-to-one surjective mapping is called a bijection). This is because the respective images should be connected satisfying both surjection and injection, and there is no conceptual supremacy existing between these images. It is to be noted that the mappings to be constructed here are the digital version of the bijection. In the base technology, a pixel is specified by a co-ordinate point.

The mapping of the source subimage (a subimage of a source image) to the destination subimage (a subimage of a destination image) is represented by f^{(m,s)}: I/2^{n-m}×I/2^{n-m}→I/2^{n-m}×I/2^{n-m}(s=0,1, . . . ) where f_{(i,j)}^{(m,s)}=(k,l) means that p_{(i,j)}^{(m,s)} of the source image is mapped to q_{(k,l)}^{(m,s)} of the destination image. For simplicity, when f(i,j)=(k,l) holds, a pixel q_{(k,l)} is denoted by q_{f(i,j)}.

When the data sets are discrete as image pixels (grid points) treated in the base technology, the definition of bijectivity is important. Here, the bijection will be defined in the following manner, where i, j, k and l are all integers. First, a square region R defined on the source image plane is considered

$${p}_{( i , j )}^{( m , s )} {p}_{( i + 1 , j )}^{( m , s )} {p}_{( i + 1 , j + 1 )}^{( m , s )} {p}_{( i , j + 1 )}^{( m , s )} \qquad ( 4 )$$

where i=0, . . . , 2^{m}−1, and j=0, . . . , 2^{m}−1. The edges of R are directed as follows:

$$\vec{{p}_{( i , j )}^{( m , s )} {p}_{( i + 1 , j )}^{( m , s )}} , \vec{{p}_{( i + 1 , j )}^{( m , s )} {p}_{( i + 1 , j + 1 )}^{( m , s )}} , \vec{{p}_{( i + 1 , j + 1 )}^{( m , s )} {p}_{( i , j + 1 )}^{( m , s )}} and \vec{{p}_{( i , j + 1 )}^{( m , s )} {p}_{( i , j )}^{( m , s )}} \qquad ( 5 )$$

This square region R will be mapped by f to a quadrilateral on the destination image plane:

$${q}_{f ( i , j )}^{( m , s )} {q}_{f ( i + 1 , j )}^{( m , s )} {q}_{f ( i + 1 , j + 1 )}^{( m , s )} {q}_{f ( i , j + 1 )}^{( m , s )} \qquad ( 6 )$$

This mapping f^{(m,s)}(R), that is,

$${f}^{( m , s )} ( R ) = {f}^{( m , s )} ( {p}_{( i , j )}^{( m , s )} {p}_{( i + 1 , j )}^{( m , s )} {p}_{( i + 1 , j + 1 )}^{( m , s )} {p}_{( i , j + 1 )}^{( m , s )} ) = {q}_{f ( i , j )}^{( m , s )} {q}_{f ( i + 1 , j )}^{( m , s )} {q}_{f ( i + 1 , j + 1 )}^{( m , s )} {q}_{f ( i , j + 1 )}^{( m , s )} )$$

should satisfy the following bijectivity conditions(referred to as BC hereinafter):

1. The edges of the quadrilateral f^{(m,s)}(R) should not intersect one another.

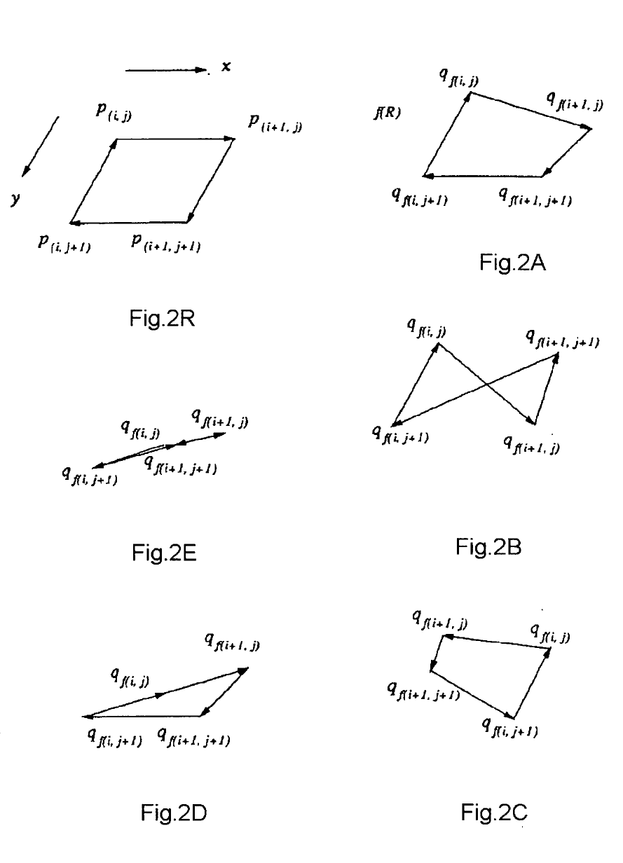

2. The orientation of the edges of f^{(m,s)}(R) should be the same as that of R (clockwise in the case shown in FIG. 2, described below).

3. As a relaxed condition, a retraction mapping is allowed.

Without a certain type of a relaxed condition as in, for example, condition 3 above, there would be no mappings which completely satisfy the BC other than a trivial identity mapping. Here, the length of a single edge of f^{(m,s)}(R) may be zero. Namely, f^{(m,s)}(R) may be a triangle. However, f^{(m,s)}(R) is not allowed to be a point or a line segment having area zero. Specifically speaking, if FIG. 2R is the original quadrilateral, FIGS. 2A and 2D satisfy the BC while FIGS. 2B, 2C and 2E do not satisfy the BC.

In actual implementation, the following condition may be further imposed to easily guarantee that the mapping is surjective. Namely, each pixel on the boundary of the source image is mapped to the pixel that occupies the same location at the destination image. In other words, f(i,j)=(i,j) (on the four lines of i=0,i=2^{m}−1, j=0,j=2^{m}−1). This condition will be hereinafter referred to as an additional condition.

[1.3.2] Energy of Mapping

[1.3.2.1] Cost Related to the Pixel Intensity

The energy of the mapping f is defined. An objective here is to search a mapping whose energy becomes minimum. The energy is determined mainly by the difference in the intensity between the pixel of the source image and its corresponding pixel of the destination image. Namely, the energy C_{(i,j)}^{(m,s)} of the mapping f^{(m,s)} at (i,j) is determined by the following equation (7).

$${C}_{( i , j )}^{( m , s )} = {\vert V ( {p}_{( i , j )}^{( m , s )} ) - V ( {q}_{f ( i , j )}^{( m , s )} ) \vert}^{2} \qquad ( 7 )$$

where V(p_{(i,j)}^{(m,s)}) and v(q_{f(i,j)}^{(m,s)}) are the intensity values of the pixels p_{(i,j)}^{(m,s)} and q_{f(i,j)}^{(m,s)}, respectively. The total energy C^{(m,s)} of f is a matching evaluation equation, and can be defined as the sum of C_{(i,j)}^{(m,s)} as shown in the following equation (8).

$${C}_{f}^{( m , s )} = {\sum }_{i = 0}^{i = {2}^{m} - 1} {\sum }_{j = 0}^{j = {2}^{m} - 1} {C}_{( i , j )}^{( m , s )} \qquad ( 8 )$$

[1.3.2.2] Cost Related to the Locations of the Pixel for Smooth Mapping

In order to obtain smooth mappings, another energy D_{f} for the mapping is introduced. The energy Df is determined by the locations of p_{(i,j)}^{(m,s)} and q_{f(i,j)}^{(m,s)}(i=0,1, . . . , 2^{m}−1, j=0,1, . . . , 2^{m}−1), regardless of the intensity of the pixels. The energy D_{(i,j)}^{(m,s)} of the mapping f^{(m,s)} at a point (i,j) is determined by the following equation (9).

$${D}_{( i , j )}^{( m , s )} = η {E}_{0 ( i , j )}^{( m , s )} + {E}_{1 ( i , j )}^{( m , s )} \qquad ( 9 )$$

where the coefficient parameter η which is equal to or greater than 0 is a real number. And we have

$$\begin{matrix}{E}_{0 ( i , j )}^{( m , s )} = {‖ ( i , j ) - {f}^{( m , s )} ( i , j ) ‖}^{2} & ( 10 ) \\ {E}_{1 ( i , j )}^{( m , s )} = {\sum }_{{i}^{′} = i - 1}^{i} {\sum }_{{j}^{′} = j - 1}^{j} {‖ ( {f}^{( m , s )} ( i , j ) - ( i , j ) ) - ( {f}^{( m , s )} ( {i}^{′} , {j}^{′} ) - ( {i}^{′} , {j}^{′} ) ) ‖}^{2} / 4 & ( 11 )\end{matrix}$$

where

∥(x,y)∥=\sqrt{x²+y²} (12)

i′ and j′ are integers and f(i′,j′) is defined to be zero for i′<0 and j′<0. E₀ is determined by the distance between (i,j) and f(i,j). E₀ prevents a pixel from being mapped to a pixel too far away from it. However, as explained below, E₀ can be replaced by another energy function. E₁ ensures the smoothness of the mapping. E₁ represents a distance between the displacement of p(i,j) and the displacement of its neighboring points. Based on the above consideration, another evaluation equation for evaluating the matching, or the energy D_{f} is determined by the following equation:

$${D}_{f}^{( m , s )} = {\sum }_{i = 0}^{i = {2}^{m} - 1} {\sum }_{j = 0}^{j = {2}^{m} - 1} {D}_{( i , j )}^{( m , s )} \qquad ( 13 )$$

[1.3.2.3] Total Energy of the Mapping

The total energy of the mapping, that is, a combined evaluation equation which relates to the combination of a plurality of evaluations, is defined as λC_{f}^{(m,s)}+D_{f}^{(m,s)}, where λ≧0 is a real number. The goal is to detect a state in which the combined evaluation equation has an extreme value, namely, to find a mapping which gives the minimum energy expressed by the following:

$${min}_{f} \{ λ {C}_{f}^{( m , s )} + {D}_{f}^{( m , s )} \} \qquad ( 14 )$$

Care must be exercised in that the mapping becomes an identity mapping if λ=0 and η=0(i.e., f^{(m,s)}(i,j)=(i,j) for all i=0,1, . . . , 2^{m}−1 and j=0,1, . . . , 2^{m}−1). As will be described later, the mapping can be gradually modified or transformed from an identity mapping since the case of λ=0 and η=0 is evaluated at the outset in the base technology. If the combined evaluation equation is defined as C_{f}^{(m,s)}+λD_{f}^{(m,s)} where the original position of λ is changed as such, the equation with λ=0 and η=0 will be C_{f}^{(m,s)} only. As a result thereof, pixels would randomly matched to each other only because their pixel intensities are close, thus making the mapping totally meaningless. Transforming the mapping based on such a meaningless mapping makes no sense. Thus, the coefficient parameter is so determined that the identity mapping is initially selected for the evaluation as the best mapping.

Similar to this base technology, differences in the pixel intensity and smoothness are considered in a technique called “optical flow” that is known in the art. However, the optical flow technique cannot be used for image transformation since the optical flow technique takes into account only the local movement of an object. However, global correspondence can also be detected by utilizing the critical point filter according to the base technology.

[1.3.3] Determining the Mapping with Multiresolution

A mapping fₘᵢₙ which gives the minimum energy and satisfies the BC is searched by using the multiresolution hierarchy. The mapping between the source subimage and the destination subimage at each level of the resolution is computed. Starting from the top of the resolution hierarchy (i.e., the coarsest level), the mapping is determined at each resolution level, and where possible, mappings at other levels are considered. The number of candidate mappings at each level is restricted by using the mappings at an upper (i.e., coarser) level of the hierarchy. More specifically speaking, in the course of determining a mapping at a certain level, the mapping obtained at the coarser level by one is imposed as a sort of constraint condition.

We thus define a parent and child relationship between resolution levels. When the following equation (15) holds,

$$( {i}^{′} , {j}^{′} ) = ( ⌊ \frac{i}{2} ⌋ , ⌊ \frac{j}{2} ⌋ ) , \qquad ( 15 )$$

where └x┘ denotes the largest integer not exceeding x,

$${p}_{( {i}^{′} , {j}^{′} )}^{( m - 1 , s )} and {q}_{( {i}^{′} , {j}^{′} )}^{( m - 1 , s )}$$

are respectively called the parents of

$${p}_{( i , j )}^{( m , s )} and {q}_{( i , j )}^{( m , s )} , .$$

Conversely,

$${p}_{( i , j )}^{( m , s )} and {q}_{( i , j )}^{( m , s )}$$

are the child of p_{(i′,j′)}^{(m-1,s)} and the child of q_{(i′,j′)}^{(m-1,s)} respectively. A function parent (i,j) is defined by the following equation (16):

$$parent ( i , j ) = ( ⌊ \frac{i}{2} ⌋ , ⌊ \frac{j}{2} ⌋ ) \qquad ( 16 )$$

Now, a mapping between p_{(i,j)}^{(m,s)} and q_{(k,l)}^{(m,s)} is determined by computing the energy and finding the minimum thereof. The value of f^{(m,s)}(i,j)=(k,l) is determined as follows using f(m−1,s) (m=1,2, . . . , n). First of all, a condition is imposed that q_{(k,l)}^{(m,s)} should lie inside a quadrilateral defined by the following definitions (17) and (18). Then, the applicable mappings are narrowed down by selecting ones that are thought to be reasonable or natural among them satisfying the BC.

$${q}_{{g}^{( m , s )} ( i - 1 , j - 1 )}^{( m , s )} {q}_{{g}^{( m , s )} ( i - 1 , j + 1 )}^{( m , s )} {q}_{{g}^{( m , s )} ( i + 1 , j + 1 )}^{( m , s )} {q}_{{g}^{( m , s )} ( i + 1 , j - 1 )}^{( m , s )} \qquad ( 77 )$$

where

$${g}^{( m , s )} ( i , j ) = {f}^{( m - 1 , s )} ( parent ( i , j ) ) + {f}^{( m - 1 , s )} ( parent ( i , j ) + ( 1 , 1 ) ) \qquad ( 18 )$$

The quadrilateral defined above is hereinafter referred to as the inherited quadrilateral of p_{(i,j)}^{(m,s)}. The pixel minimizing the energy is sought and obtained inside the inherited quadrilateral.

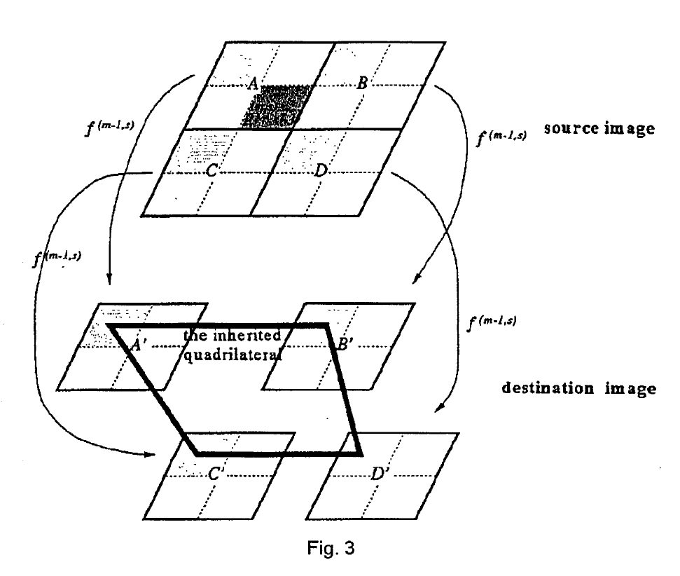

FIG. 3 illustrates the above-described procedures. The pixels A, B, C and D of the source image are mapped to A′, B′, C′ and D′ of the destination image, respectively, at the (m−1)th level in the hierarchy. The pixel p_{(i,j)}^{(m,s)} should be mapped to the pixel q_{f}_{^{(m)}}_{(i,j)}^{(m,s)} which exists inside the inherited quadrilateral A′B′C′D′. Thereby, bridging from the mapping at the (m−1)th level to the mapping at the m-th level is achieved.

The energy E₀ defined above may now be replaced by the following equations (19) and (20):

$$\begin{matrix}{E}_{0 ( i , j )} = {‖ {f}^{( m , 0 )} ( i , j ) - {g}^{( m )} ( i , j ) ‖}^{2} & ( 19 ) \\ {E}_{0 ( i , j )} = {‖ {f}^{( m , s )} ( i , j ) - {f}^{( m , s - 1 )} ( i , j ) ‖}^{2} , ( 1 \leq i ) & ( 20 )\end{matrix}$$

for computing the submapping f^{(m,0)} and the submapping f^{(m,s)} at the m-th level, respectively.

In this manner, a mapping which maintains a low energy of all the submappings is obtained. Using the equation (20) makes the submappings corresponding to the different critical points associated to each other within the same level in order that the subimages can have high similarity. The equation (19) represents the distance between f^{(m,s)}(i,j) and the location where (i,j) should be mapped when regarded as a part of a pixel at the (m−1)the level.

When there is no pixel satisfying the BC inside the inherited quadrilateral A′B′C′D′, the following steps are taken. First, pixels whose distance from the boundary of A′B′C′D′ is L (at first, L=1) are examined. If a pixel whose energy is the minimum among them satisfies the BC, then this pixel will be selected as a value of f^{(m,s)}(i,j). L is increased until such a pixel is found or L reaches its upper bound Lₘₐₓ^{(m)}. Lₘₐₓ^{(m)}is fixed for each level m. If no pixel is found at all, the third condition of the BC is ignored temporarily and such mappings that caused the area of the transformed quadrilateral to become zero (a point or a line) will be permitted so as to determine f^{(m,s)}(i,j). If such a pixel is still not found, then the first and the second conditions of the BC will be removed.

Multiresolution approximation is essential to determining the global correspondence of the images while preventing the mapping from being affected by small details of the images. Without the multiresolution approximation, it is impossible to detect a correspondence between pixels whose distances are large. In the case where the multiresolution approximation is not available, the size of an image will generally be limited to a very small size, and only tiny changes in the images can be handled. Moreover, imposing smoothness on the mapping usually makes it difficult to find the correspondence of such pixels. That is because the energy of the mapping from one pixel to another pixel which is far therefrom is high. On the other hand, the multiresolution approximation enables finding the approximate correspondence of such pixels. This is because the distance between the pixels is small at the upper (coarser) level of the hierarchy of the resolution.

[1.4] Automatic Determination of the Optimal Parameter Values

One of the main deficiencies of the existing image matching techniques lies in the difficulty of parameter adjustment. In most cases, the parameter adjustment is performed manually and it is extremely difficult to select the optimal value. However, according to the base technology, the optimal parameter values can be obtained completely automatically.

The systems according to this base technology include two parameters, namely, λ and η, where λ and η represent the weight of the difference of the pixel intensity and the stiffness of the mapping, respectively. In order to automatically determine these parameters, the are initially set to 0. First, λ is gradually increased from λ=0 while η is fixed at 0. As λ becomes larger and the value of the combined evaluation equation (equation (14)) is minimized, the value of C_{f}^{(m,s)} for each submapping generally becomes smaller. This basically means that the two images are matched better. However, if λ exceeds the optimal value, the following phenomena occur:

1. Pixels which should not be corresponded are erroneously corresponded only because their intensities are close.

2. As a result, correspondence between images becomes inaccurate, and the mapping becomes invalid.

3. As a result, D_{f}^{(m,s)} in equation (14) tends to increase abruptly.

4. As a result, since the value of equation (14) tends to increase abruptly, f^{(m,s)} changes in order to suppress the abrupt increase of D_{f}^{(m,s)}. As a result, C_{f}^{(m,s)} increases.

Therefore, a threshold value at which C_{f}^{(m,s)} turns to an increase from a decrease is detected while a state in which equation (14) takes the minimum value with λ being increased is kept. Such λ is determined as the optimal value at η=0. Next, the behavior of C_{f}^{(m,s)} is examined while η is increased gradually, and η will be automatically determined by a method described later. λ will then again be determined corresponding to such an automatically determined η.

The above-described method resembles the focusing mechanism of human visual systems. In the human visual systems, the images of the respective right eye and left eye are matched while moving one eye. When the objects are clearly recognized, the moving eye is fixed.

[1.4.1] Dynamic Determination of λ

Initially, λ is increased from 0 at a certain interval, and a subimage is evaluated each time the value of λ changes. As shown in equation (14), the total energy is defined by

$$λ {C}_{f}^{( m , s )} + {D}_{f}^{( m , s )} . {D}_{( i , j )}^{( m , s )}$$

in equation (9) represents the smoothness and theoretically becomes minimum when it is the identity mapping. E₀ and E₁ increase as the mapping is further distorted. Since E₁ is an integer, 1 is the smallest step of D_{f}^{(m,s)}. Thus, it is impossible to change the mapping to reduce the total energy unless a changed amount (reduction amount) of the current λC_{(i,j)}^{(m,s)} is equal to or greater than 1. Since D_{f}^{(m,s)} increases by more than 1 accompanied by the change of the mapping, the total energy is not reduced unless λC_{(i,j)}^{(m,s)} is reduced by more than 1.

Under this condition, it is shown that C_{(i,j)}^{(m,s)} decreases in normal cases as λ increases. The histogram of C_{(i,j)}^{(m,s)} is denoted as h(l), where h(l) is the number of pixels whose energy C_{(i,j)}^{(m,s)} is l². In order that λl²≧1 for example, the case of l²=1/λ is considered. When λ varies from λ₁ to λ₂, a number of pixels (denoted A) expressed by the following equation (21):

$$A = {\sum }_{l = ⌈ \frac{1}{{λ}_{2}} ⌉}^{⌊ \frac{1}{{λ}_{1}} ⌋} h ( l ) ≅ {\int }_{l = \frac{1}{{λ}_{2}}}^{\frac{1}{{λ}_{1}}} h ( l ) ⅆ l = - {\int }_{{λ}_{2}}^{{λ}_{1}} h ( l ) \frac{1}{{λ}^{3 / 2}} ⅆ λ = {\int }_{{λ}_{1}}^{{λ}_{2}} \frac{h ( l )}{{λ}^{3 / 2}} ⅆ λ \qquad ( 21 )$$

changes to a more stable state having the energy shown in equation(22)

$${C}_{f}^{( m , s )} - {l}^{2} = {C}_{f}^{( m , s )} - \frac{1}{λ} . \qquad ( 22 )$$

Here, it is assumed that the energy of these pixels is approximated to be zero. This means that the value of C_{(i,j)}^{(m,s)} changes by:

$$\partial {C}_{f}^{( m , s )} = - \frac{A}{λ} \qquad ( 23 )$$

As a result, equation (24) holds.

$$\frac{\partial {C}_{f}^{( m , s )}}{\partial λ} = - \frac{h ( l )}{{λ}^{5 / 2}} \qquad ( 24 )$$

Since h(l)>0,C_{f}^{(m,s)} decreases in the normal case. However, when λ exceeds the optimal value, the above phenomenon, that is, an increase in C_{f}^{(m,s)} occurs. The optimal value of λ is determined by detecting this phenomenon.

When

$$h ( l ) = H {l}^{k} = \frac{H}{{λ}^{k / 2}} \qquad ( 25 )$$

is assumed, where both H(H>0) and k are constants, the equation (26) holds:

$$\frac{\partial {C}_{f}^{( m , s )}}{\partial λ} = - \frac{H}{{λ}^{5 / 2 + k / 2}} \qquad ( 26 )$$

Then, if k≠−3, the following equation (27) holds:

$${C}_{f}^{( m , s )} = C + \frac{H}{( 3 / 2 + k / 2 ) {λ}^{3 / 2 + k / 2}} \qquad ( 27 )$$

The equation (27) is a general equation of

$${C}_{f}^{( m , s )}$$

(where C is a constant).

When detecting the optimal value of λ, the number of pixels violating the BC may be examined for safety. In the course of determining a mapping for each pixel, the probability of violating the BC is assumed as a value po here. In this case, since

$$\frac{\partial A}{\partial λ} = \frac{h ( l )}{{λ}^{3 / 2}} \qquad ( 28 )$$

holds, the number of pixels violating the BC increases at a rate of:

$${B}_{0} = \frac{h ( l ) {p}_{0}}{{λ}^{3 / 2}} \qquad ( 29 )$$

Thus,

$$\frac{{B}_{0} {λ}^{3 / 2}}{{p}_{0} h ( l )} = 1 \qquad ( 30 )$$

is a constant. If it is assumed that h(l)=Hl^{k}, the following equation (31), for example,

B₀λ^{3/2+k/2}=p₀H (31)

becomes a constant. However, when λ exceeds the optimal value, the above value of equation (31) increases abruptly. By detecting this phenomenon, i.e. whether or not the value of

$${B}_{0} {λ}^{3 / 2 + k / 2} / {2}^{m}$$

exceeds an abnormal value B₀ₜₕᵣₑₛ, the optimal value of λ can be determined. Similarly, whether or not the value of

$${B}_{1} {λ}^{3 / 2 + k / 2} / {2}^{m}$$

exceeds an abnormal value B₁ₜₕᵣₑₛ can be used to check for an increasing rate B₁ of pixels violating the third condition of the BC. The reason why the factor 2^{m} is introduced here will be described at a later stage. This system is not sensitive to the two threshold values B₀ₜₕᵣₑₛ and B₁ₜₕᵣₑₛ. The two threshold values B₀ₜₕᵣₑₛ and B₁ₜₕᵣₑₛ can be used to detect excessive distortion of the mapping which may not be detected through observation of the energy C_{f}^{(m,s)}.

In the experimentation, when λ exceeded 0.1 the computation of f^{(m,s)} was stopped and the computation of f^{(m,s+1)} was started. That is because the computation of submappings is affected by a difference of only 3 out of 255 levels in pixel intensity when λ>0.1 and it is then difficult to obtain a correct result.

[1.4.2] Histogram h(l)

The examination of C_{f}^{(m,s)} does not depend on the histogram h(l), however, the examination of the BC and its third condition may be affected by h(l). When (λ, C_{f}^{(m,s)}) is actually plotted, k is usually close to 1. In the experiment, k=1 is used, that is, B₀λ² and B₁λ² are examined. If the true value of k is less than 1, B₀λ² and B₁λ² are not constants and increase gradually by a factor of λ^{(1-k)/2}. If h(l) is a constant, the factor is, for example, λ^{½}. However, such a difference can be absorbed by setting the threshold B₀ₜₕᵣₑₛ appropriately.

Let us model the source image by a circular object, with its center at (x₀, y₀) and its radius r, given by:

$$p ( i , j ) = \{ \begin{matrix}\frac{255}{r} c ( \sqrt{{( i - {x}_{0} )}^{2} + {( j - {y}_{0} )}^{2}} ) … ( \sqrt{{( i - {x}_{0} )}^{2} + {( j - {y}_{0} )}^{2}} \leq r ) \\ 0 … ( otherwise )\end{matrix} \qquad ( 32 )$$

and the destination image given by:

$$q ( i , j ) = \{ \begin{matrix}\frac{255}{r} c ( \sqrt{{( i - {x}_{1} )}^{2} + {( j - {y}_{1} )}^{2}} ) … ( \sqrt{{( i - {x}_{1} )}^{2} + {( j - {y}_{1} )}^{2}} \leq r ) \\ 0 … ( otherwise )\end{matrix} \qquad ( 33 )$$

with its center at (x₁,y₁) and radius r. In the above, let c(x) have the form of c(x)=x^{k}. When the centers (x₀,y₀) and (x₁,y₁) are sufficiently far from each other, the histogram h(l) is then in the form:

h(l)∝rl^{k}(k≠0) (34)

When k=1, the images represent objects with clear boundaries embedded in the background. These objects become darker toward their centers and brighter toward their boundaries. When k=−1, the images represent objects with vague boundaries. These objects are brightest at their centers, and become darker toward their boundaries. Without much loss of generality, it suffices to state that objects in images are generally between these two types of objects. Thus, choosing k such that —1≦k≦1 can cover most cases and the equation (27) is generally a decreasing function for this range.

As can be observed from the above equation (34), attention must be directed to the fact that r is influenced by the resolution of the image, that is, r is proportional to 2^{m}. This is the reason for the factor 2^{m} being introduced in the above section [1.4.1].

[1.4.3] Dynamic Determination of η

The parameter η can also be automatically determined in a similar manner. Initially, η is set to zero, and the final mapping f⁽ⁿ⁾ and the energy C_{f}⁽ⁿ⁾ at the finest resolution are computed. Then, after η is increased by a certain value Δη, the final mapping f⁽ⁿ⁾ and the energy C_{f}⁽ⁿ⁾ at the finest resolution are again computed. This process is repeated until the optimal value of η is obtained. η represents the stiffness of the mapping because it is a weight of the following equation (35):

$${E}_{{0}_{( i , j )}}^{( m , s )} = {‖ {f}^{( m , s )} ( i , j ) - {f}^{( m , s - 1 )} ( i , j ) ‖}^{2} \qquad ( 35 )$$

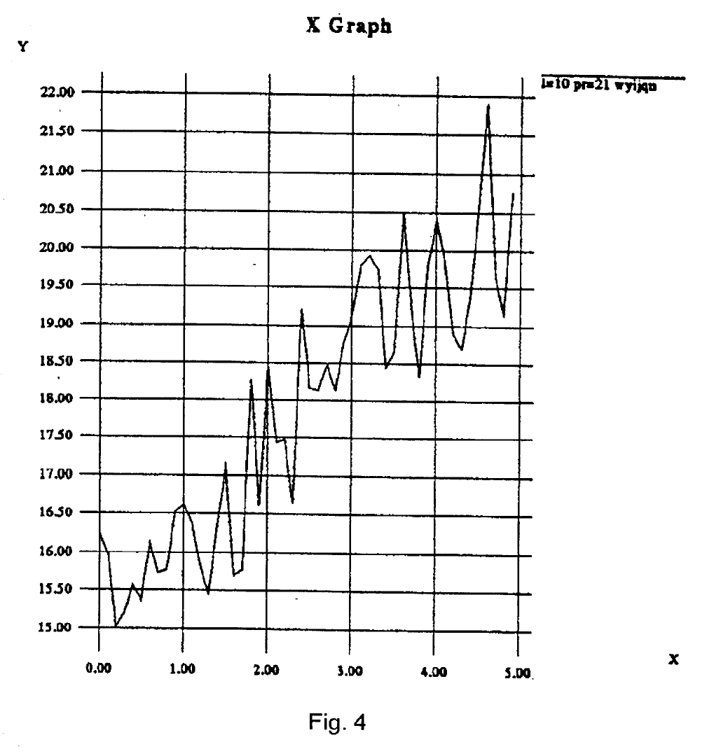

If η is zero, D_{f}⁽ⁿ⁾ is determined irrespective of the previous submapping, and the present submapping may be elastically deformed and become too distorted. On the other hand, if η is a very large value, D_{f}⁽ⁿ⁾ is almost completely determined by the immediately previous submapping. The submappings are then very stiff, and the pixels are mapped to almost the same locations. The resulting mapping is therefore the identity mapping. When the value of η increases from 0, C_{f}⁽ⁿ⁾ gradually decreases as will be described later. However, when the value of η exceeds the optimal value, the energy starts increasing as shown in FIG. 4. In FIG. 4, the x-axis represents η, and y-axis represents C_{f}.

The optimum value of η which minimizes C_{f}⁽ⁿ⁾ can be obtained in this manner. However, since various elements affect this computation as compared to the case of λ, C_{f}⁽ⁿ⁾ changes while slightly fluctuating. This difference is caused because a submapping is re-computed once in the case of λ whenever an input changes slightly, whereas all the submappings must be re-computed in the case of λ. Thus, whether the obtained value of C_{f}⁽ⁿ⁾ is the minimum or not cannot be determined as easily. When candidates for the minimum value are found, the true minimum needs to be searched by setting up further finer intervals.

[1.5] Supersampling

When deciding the correspondence between the pixels, the range of f_{(m,s)} can be expanded to R×R (R being the set of real numbers) in order to increase the degree of freedom. In this case, the intensity of the pixels of the destination image is interpolated, to provide f^{(m,s)} having an intensity at non-integer points:

$$V ( {q}_{{f}^{( m , s )} ( i , j )}^{( m , s )} ) \qquad ( 36 )$$

That is, supersampling is performed. In an example implementation, f^{(m,s)} may take integer and half integer values, and

$$V ( {q}_{( i , j ) + ( 0.5 .0 .5 )}^{( m , s )} ) \qquad ( 37 )$$

is given by

$$( V ( {q}_{( i , j )}^{( m , s )} ) + V ( {q}_{( i , j ) + ( 1 , 1 )}^{( m , s )} ) ) / 2 \qquad ( 38 )$$

[1.6] Normalization of the Pixel Intensity of Each Image

When the source and destination images contain quite different objects, the raw pixel intensity may not be used to compute the mapping because a large difference in the pixel intensity causes excessively large energy C_{f}^{(m,s)} and thus making it difficult to obtain an accurate evaluation.

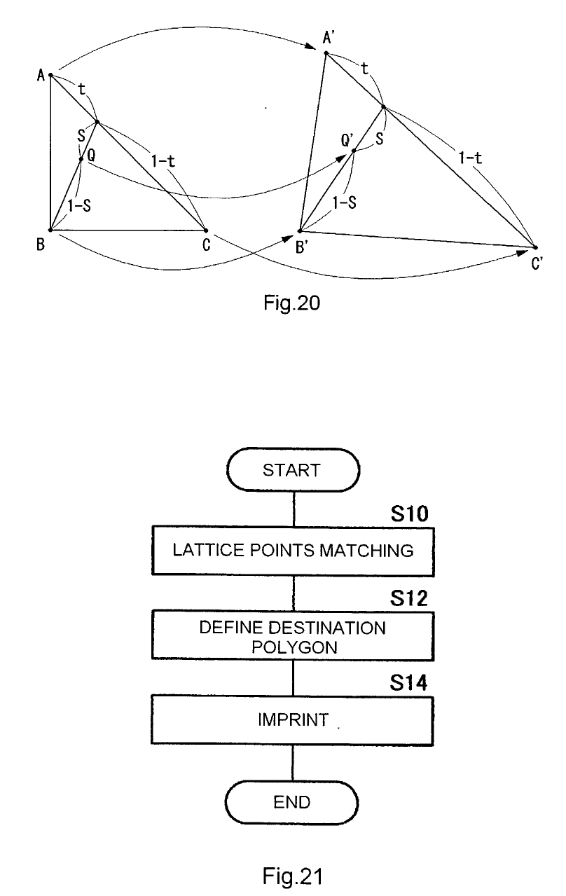

For example, a matching between a human face and a cat's face is computed as shown in FIGS. 20(a) and 20(b). The cat's face is covered with hair and is a mixture of very bright pixels and very dark pixels. In this case, in order to compute the submappings of the two faces, subimages are normalized. That is, the darkest pixel intensity is set to 0 while the brightest pixel intensity is set to 255, and other pixel intensity values are obtained using linear interpolation.

[1.7] Implementation

In an example implementation, a heuristic method is utilized wherein the computation proceeds linearly as the source image is scanned. First, the value of f^{(m,s)} is determined at the top leftmost pixel (i,j)=(0,0). The value of each f^{(m,s)}(i,j) is then determined while i is increased by one at each step. When i reaches the width of the image, j is increased by one and i is reset to zero. Thereafter, f^{(m,s)}(i,j) is determined while scanning the source image. Once pixel correspondence is determined for all the points, it means that a single mapping f^{(m,s)} is determined.

When a corresponding point q_{f(i,j)} is determined for p_{f(i,j)}, a corresponding point q_{f(i,j+1)} of p_{(i,j+1)} is determined next. The position of q_{f(i,j+1)} is constrained by the position of qf(i,j) since the position of q_{f(i,j+1)} satisfies the BC. Thus, in this system, a point whose corresponding point is determined earlier is given higher priority. If the situation continues in which (0,0) is always given the highest priority, the final mapping might be unnecessarily biased. In order to avoid this bias, f^{(m,s)} is determined in the following manner in the base technology.

First, when (s mod 4) is 0, f^{(m,s)} is determined starting from (0,0) while gradually increasing both i and j. When (s mod 4) is 1, f^{(m,s)} is determined starting from the top rightmost location while decreasing i and increasing j. When (s mod 4) is 2, f^{(m,s)} is determined starting from the bottom rightmost location while decreasing both i and j. When (s mod 4) is 3, f^{(m,s)} is determined starting from the bottom leftmost location while increasing i and decreasing j. Since a concept such as the submapping, that is, a parameter s, does not exist in the finest n-th level, f^{(m,s)} is computed continuously in two directions on the assumption that s=0 and s=2.

In this implementation, the values of f^{(m,s)}(i,j) (m=0, . . . , n) that satisfy the BC are chosen as much as possible from the candidates (k,l) by imposing a penalty on the candidates violating the BC. The energy D_{(k,l)} of a candidate that violates the third condition of the BC is multiplied by φ and that of a candidate that violates the first or second condition of the BC is multiplied by ψ. In this implementation, φ=2 and ψ=100000 are used.

In order to check the above-mentioned BC, the following test may be performed as the procedure when determining (k,l)=f^{(m,s)}(i,j). Namely, for each grid point (k,l) in the inherited quadrilateral of f^{(m,s)}(i,j), whether or not the z-component of the outer product of

W=\vec{A}×\vec{B} (39)

is equal to or greater than 0 is examined, where

$$\begin{matrix}\vec{A} = \vec{{q}_{{f}^{( m , s )} ( i , j - 1 )}^{( m , s )} {q}_{{f}^{( m , s )} ( i + 1 , j - 1 )}^{( m , s )}} & ( 40 ) \\ \vec{B} = \vec{{q}_{{f}^{( m , s )} ( i , j - 1 )}^{( m , s )} {q}_{( k , l )}^{( m , s )}} & ( 41 )\end{matrix}$$

Here, the vectors are regarded as 3D vectors and the z-axis is defined in the orthogonal right-hand coordinate system. When W is negative, the candidate is imposed with a penalty by multiplying

$${D}_{( k , l )}^{( m , s )}$$

by ψ so that it is not as likely to be selected.

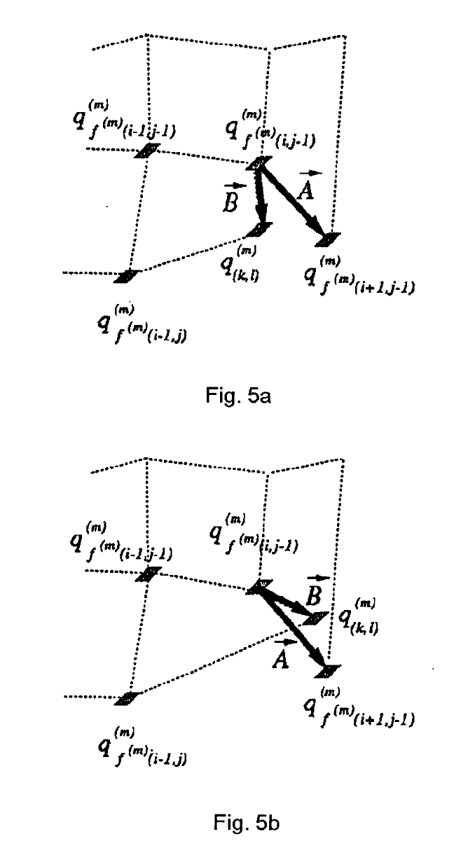

FIGS. 5(a) and 5(b) illustrate the reason why this condition is inspected. FIG. 5(a) shows a candidate without a penalty and FIG. 5(b) shows one with a penalty. When determining the mapping f^{(m,s)}(i,j+1) for the adjacent pixel at (i,j+1), there is no pixel on the source image plane that satisfies the BC if the z-component of W is negative because then

$${q}_{( k , l )}^{{( m , s )}^{.}}$$

passes the boundary of the adjacent quadrilateral.

[1.7.1] The Order of Submappings

In this implementation, σ(0)=0, σ(1)-=1, σ(2)=2, σ(3)=3, σ(4)=0 are used when the resolution level is even, while σ(0)=3, σ(1)=2, σ(2)=1,σ(3)=0, σ(4)=3 are used when the resolution level is odd. Thus, the submappings are shuffled to some extent. It is to be noted that the submappings are primarily of four types, and s may be any of 0 to 3. However, a processing with s=4 is used in this implementation for a reason to be described later.

[1.8] Interpolations

After the mapping between the source and destination images is determined, the intensity values of the corresponding pixels are interpolated. In the implementation, trilinear interpolation is used. Suppose that a square p_{(i,j)}p_{(i+1,j)}p_{(i+1,j+1)}p_{(i,j+1)} on the source image plane is mapped to a quadrilateral q_{(i,j)}q_{(i+1,j)}q_{(i+1,j+1)}q_{(i,j+1)} on the destination image plane. For simplicity, the distance between the image planes is assumed to be 1. The intermediate image pixels r(x,y,t) (0≦x≦N−1, 0≦y≦M−1) whose distance from the source image plane is t (0≦t≦1) are obtained as follows. First, the location of the pixel r(x,y,t), where x,y,t∈R, is determined by equation (42):

$$\begin{matrix}( x , y ) = ( 1 - dx ) ( 1 - dy ) ( 1 - t ) ( i , j ) + ( 1 - dx ) ( 1 - dy ) tf ( i , j ) + \\ dx ( 1 - dy ) ( 1 - t ) ( i + 1 , j ) + dx ( 1 - dy ) tf ( i + 1 , j ) + \\ ( 1 - dx ) dy ( 1 - t ) ( i , j + 1 ) + ( 1 - dx ) dytf ( i , j + 1 ) + \\ dxdy ( 1 - t ) ( i + 1 , j + 1 ) + dxdytf ( i + 1 , j + 1 )\end{matrix} \qquad ( 42 )$$

The value of the pixel intensity at r(x,y,t) is then determined by equation (43):

$$\begin{matrix}V ( r ( x , y , t ) ) = ( 1 - dx ) ( 1 - dy ) ( 1 - t ) V ( {p}_{( i , j )} ) + \\ ( 1 - dx ) ( 1 - dy ) tV ( {q}_{f ( i , j )} ) + \\ dx ( 1 - dy ) ( 1 - t ) V ( {p}_{( i + 1 , j )} ) + \\ dx ( 1 - dy ) tV ( {q}_{j ( i + 1 , j )} ) + \\ ( 1 - dx ) dy ( 1 - t ) V ( {p}_{( i , j + 1 )} ) + \\ ( 1 - dx ) dytV ( {q}_{f ( i , j + 1 )} ) + \\ dxdy ( 1 - t ) V ( {p}_{( i + 1 , j + 1 )} ) + dxdytV ( {q}_{f ( i + 1 , j + 1 )} )\end{matrix} \qquad ( 43 )$$

where dx and dy are parameters varying from 0 to 1.

[1.9] Mapping to Which Constraints are Imposed

So far, the determination of a mapping in which no constraints are imposed has been described. However, if a correspondence between particular pixels of the source and destination images is provided in a predetermined manner, the mapping can be determined using such correspondence as a constraint.

The basic idea is that the source image is roughly deformed by an approximate mapping which maps the specified pixels of the source image to the specified pixels of the destination image and thereafter a mapping f is accurately computed.

First, the specified pixels of the source image are mapped to the specified pixels of the destination image, then the approximate mapping that maps other pixels of the source image to appropriate locations are determined. In other words, the mapping is such that pixels in the vicinity of a specified pixel are mapped to locations near the position to which the specified one is mapped. Here, the approximate mapping at the m-th level in the resolution hierarchy is denoted by F^{(m)}.

The approximate mapping F is determined in the following manner. First, the mappings for several pixels are specified. When nₛ pixels

$$p ( {i}_{0} , {j}_{0} ) , p ( {i}_{1} , {j}_{1} ) , … , p ( {i}_{{n}_{s} - 1} , {j}_{{n}_{s} - 1} ) \qquad ( 44 )$$

of the source image are specified, the following values in the equation (45) are determined.

$${F}^{( n )} ( {i}_{0} , {j}_{0} ) = ( {k}_{0} , {l}_{0} ) , \\ {F}^{( n )} ( {i}_{1} , {j}_{1} ) = ( {k}_{1} , {l}_{1} ) , … , \\ {F}^{( n )} ( {i}_{{n}_{s} - 1} , {j}_{{n}_{s} - 1} ) = ( {k}_{{n}_{s} - 1} , {l}_{{n}_{s} - 1} ) \qquad ( 45 )$$

For the remaining pixels of the source image, the amount of displacement is the weighted average of the displacement of p(iₕ, iₕ) (h=0, . . . , nₛ−1). Namely, a pixel p_{(i,j)} is mapped to the following pixel (expressed by the equation (46)) of the destination image.

$${F}^{( m )} ( i , j ) = \frac{( i , j ) + {\sum }_{h = 0}^{h - {n}_{s} - 1} ( {k}_{h} - {i}_{h} , {l}_{h} - {j}_{h} ) {weight}_{h} ( i , j )}{{2}^{n - m}} \qquad ( 46 )$$

where

$${weight}_{h} ( i , j ) = \frac{1 / {‖ ( {i}_{h} - i , {j}_{h} - j ) ‖}^{2}}{total\_weight ( i , j )} \qquad ( 47 )$$

where

$$total\_weight ( i , j ) = {\sum }_{h = 0}^{h = {n}_{s} - 1} 1 / {‖ ( {i}_{h} - i , {j}_{h} - j ) ‖}^{2} \qquad ( 48 )$$

Second, the energy D_{(i,j)}^{(m,s)} of the candidate mapping f is changed so that a mapping f similar to F^{(m)} has a lower energy. Precisely speaking, D_{(i,j)}^{(m,s)} is expressed by the equation (49):

$${D}_{( i , j )}^{( m , s )} = {E}_{{0}_{( i , j )}}^{( m , s )} + η {E}_{{1}_{( i , j )}}^{( m , s )} + κ {E}_{{2}_{( i , j )}}^{( m , s )} \qquad ( 49 )$$

where

$${E}_{{2}_{( i , j )}}^{( m , s )} = \{ \begin{matrix}0 , & if {‖ {F}^{( m )} ( i , j ) - {f}^{( m , s )} ( i , j ) ‖}^{2} \leq ⌊ \frac{{ρ}^{2}}{{2}^{2 ( n - m )}} ⌋ \\ {‖ {F}^{( m )} ( i , j ) - {f}^{( m , s )} ( i , j ) ‖}^{2} , & otherwise\end{matrix} \qquad ( 50 )$$

where κ, ρ≧0. Finally, the resulting mapping f is determined by the above-described automatic computing process.

Note that E₂_{_{(i,j)}}^{(m,s)} becomes 0 if f^{(m,s)}(i,j) is sufficiently close to F^{(m)}(i,j) i.e., the distance therebetween is equal to or less than

$$⌊ \frac{{ρ}^{2}}{{2}^{2 ( n - m )}} ⌋ . \qquad ( 51 )$$

This has been defined in this way because it is desirable to determine each value f^{(m,s)}(i,j) automatically to fit in an appropriate place in the destination image as long as each value f^{(m,s)}(i,j) is close to F^{(m)}(i,j). For this reason, there is no need to specify the precise correspondence in detail to have the source image automatically mapped so that the source image matches the destination image.

[2] Concrete Processing Procedure

The flow of a process utilizing the respective elemental techniques described in [1] will now be described.

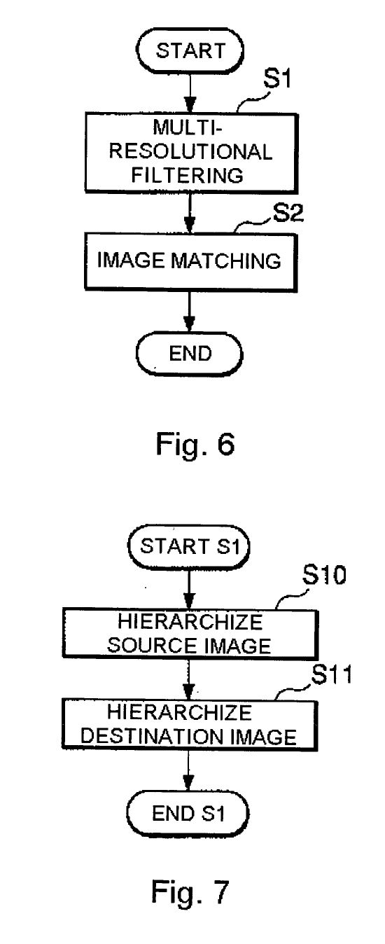

FIG. 6 is a flowchart of the overall procedure of the base technology. Referring to FIG. 6, a source image and destination image are first processed using a multiresolutional critical point filter (S1). The source image and the destination image are then matched (S2). As will be understood, the matching (S2) is not required in every case, and other processing such as image recognition may be performed instead, based on the characteristics of the source image obtained at S1.

FIG. 7 is a flowchart showing details of the process S1 shown in FIG. 6. This process is performed on the assumption that a source image and a destination image are matched at S2. Thus, a source image is first hierarchized using a critical point filter (S10) so as to obtain a series of source hierarchical images. Then, a destination image is hierarchized in the similar manner (S11) so as to obtain a series of destination hierarchical images. The order of S10 and S11 in the flow is arbitrary, and the source image and the destination image can be generated in parallel. It may also be possible to process a number of source and destination images as required by subsequent processes.

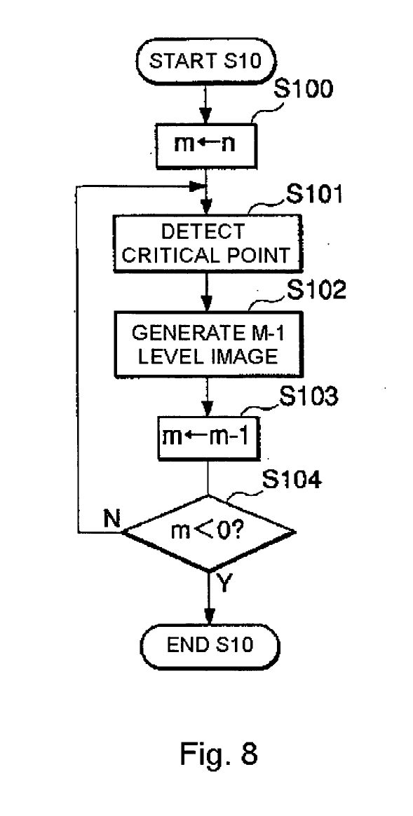

FIG. 8 is a flowchart showing details of the process at S10 shown in FIG. 7. Suppose that the size of the original source image is 2ⁿ×2ⁿ. Since source hierarchical images are sequentially generated from an image with a finer resolution to one with a coarser resolution, the parameter m which indicates the level of resolution to be processed is set to n (S100). Then, critical points are detected from the images p^{(m,0)}, p^{(m,1)}, p^{(m,2)} and p^{(m,3)} of the m-th level of resolution, using a critical point filter (S101), so that the images p^{(m-1,0)}, p^{(m-1,1)}, p^{(m-1,2)} and p of the (m−1)th level are generated (S102). Since m=n here, p^{(m,0)}=p^{(m,1)}=p^{(m,2)}=p^{(m,3)}=p⁽ⁿ⁾ holds and four types of subimages are thus generated from a single source image.

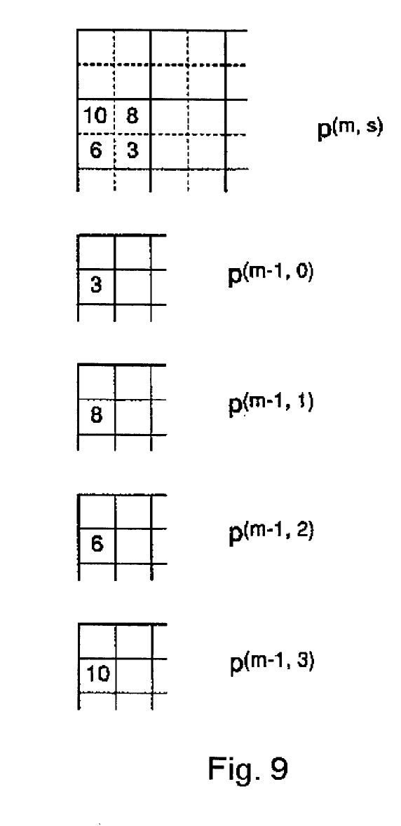

FIG. 9 shows correspondence between partial images of the m-th and those of (m−1)th levels of resolution. Referring to FIG. 9, respective numberic values shown in the figure represent the intensity of respective pixels. p^{(m,s)} symbolizes any one of four images p^{(m,0)} through p^{(m,3)}, and when generating p^{(m-1,0)}, p^{(m,0)} is used from p^{(m,s)}. For example, as for the block shown in FIG. 9, comprising four pixels with their pixel intensity values indicated inside, images p^{(m-1,0)}, p^{(m-1,1)}, p^{(m-1,2)} and p^{(m-1,3)} acquire “3”, “8”, “6” and “10”, respectively, according to the rules described in [1.2]. This block at the m-th level is replaced at the (m-l)th level by respective single pixels thus acquired. Therefore, the size of the subimages at the (m−1)th level is 2^{m-1}×2^{m-1}.

After m is decremented (S103 in FIG. 8), it is ensured that m is not negative (S104). Thereafter, the process returns to S101, so that subimages of the next level of resolution, i.e., a next coarser level, are generated. The above process is repeated until subimages at m=0(0-th level) are generated to complete the process at S10. The size of the subimages at the 0-th level is 1×1.

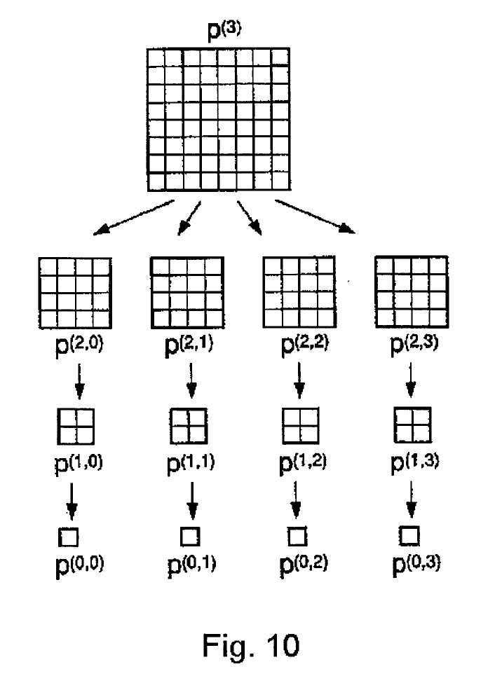

FIG. 10 shows source hierarchical images generated at S10 in the case of n=3. The initial source image is the only image common to the four series followed. The four types of subimages are generated independently, depending on the type of critical point. Note that the process in FIG. 8 is common to S11 shown in FIG. 7, and that destination hierarchical images are generated through a similar procedure. Then, the process at S1 in FIG. 6 is completed.

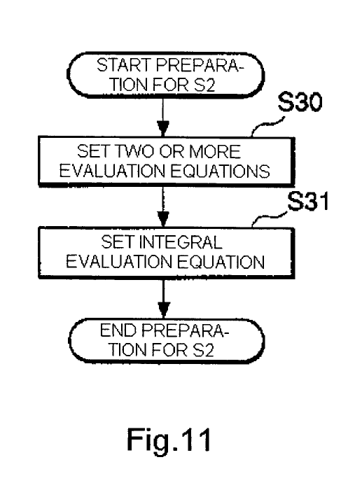

In this base technology, in order to proceed to S2 shown in FIG. 6 a matching evaluation is prepared. FIG. 11 shows the preparation procedure. Referring to FIG. 11, a plurality of evaluation equations are set (S30). The evaluation equations may include the energy C_{f}^{(m,s)} concerning a pixel value, introduced in [1.3.2.1], and the energy D_{f}^{(m,s)} concerning the smoothness of the mapping introduced in [1.3.2.2]. Next, by combining these evaluation equations, a combined evaluation equation is set (S31). Such a combined evaluation equation may be λC_{(i,j)}^{(m,s)}+D_{f}^{(m,s)}. Using η introduced in [1.3.2.2], we have

$$\sum \sum ( λ {C}_{( i , j )}^{( m , s )} + η {E}_{{0}_{( i , j )}}^{( m , s )} + {E}_{{1}_{( i , j )}}^{( m , s )} ) \qquad ( 52 )$$

In the equation (52) the sum is taken for each i and j where i and j run through 0, 1, . . . , 2^{m-1}. Now, the preparation for matching evaluation is completed.

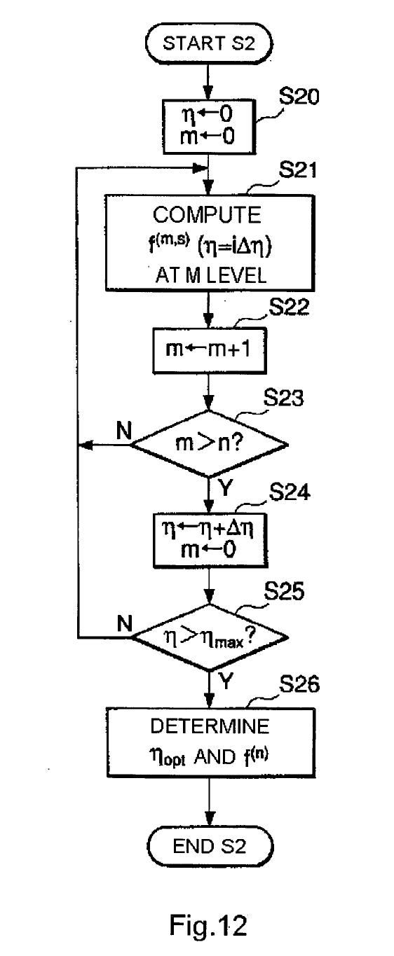

FIG. 12 is a flowchart showing the details of the process of S2 shown in FIG. 6. As described in [1], the source hierarchical images and destination hierarchical images are matched between images having the same level of resolution. In order to detect global correspondence correctly, a matching is calculated in sequence from a coarse level to a fine level of resolution. Since the source and destination hierarchical images are generated using the critical point filter, the location and intensity of critical points are stored clearly even at a coarse level. Thus, the result of the global matching is superior to conventional methods.

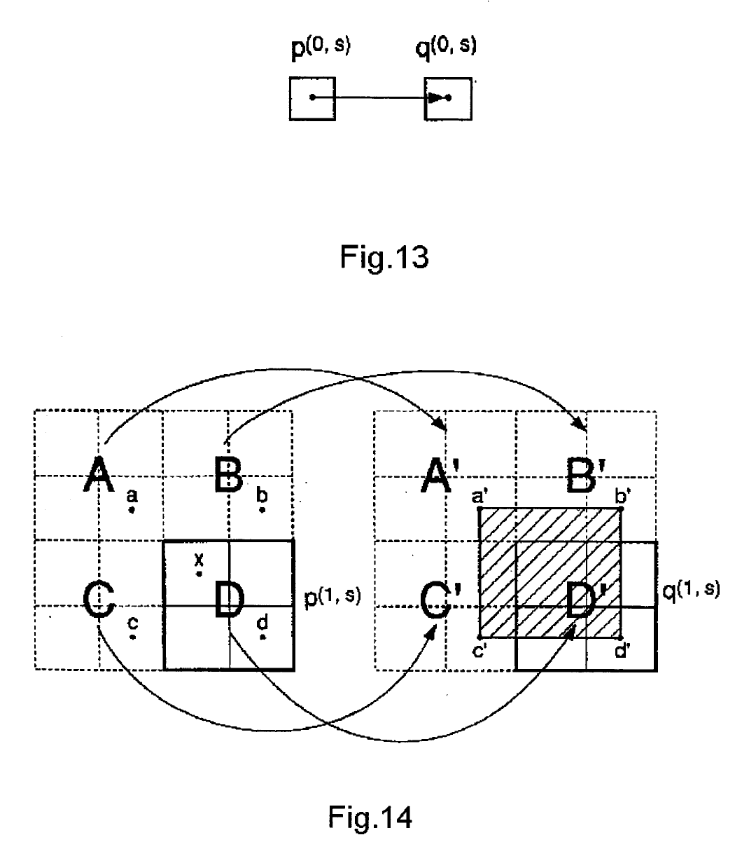

Referring to FIG. 12, a coefficient parameter n and a level parameter m are set to 0(S20). Then, a matching is computed between the four subimages at the m-th level of the source hierarchical images and those of the destination hierarchical images at the m-th level, so that four types of submappings f^{(m,s)}(s=0, 1, 2, 3) which satisfy the BC and minimize the energy are obtained (S21). The BC is checked by using the inherited quadrilateral described in [1.3.3]. In that case, the submappings at the m-th level are constrained by those at the (m−1)th level, as indicated by the equations (17) and (18). Thus, the matching computed at a coarser level of resolution is used in subsequent calculation of a matching. This is called a vertical reference between different levels. If m=0, there is no coarser level and this exceptional case will be described using FIG. 13.

A horizontal reference within the same level is also performed. As indicated by the equation (20) in [1.3.3], f^{(m,3)}, f^{(m,2)} and f^{(m,1)} are respectively determined so as to be analogous to f^{(m,2)}, f^{(m,1)} and f^{(m,0)}. This is because a situation in which the submappings are totally different seems unnatural even though the type of critical points differs so long as the critical points are originally included in the same source and destination images. As can been seen from the equation (20), the closer the submappings are to each other, the smaller the energy becomes, so that the matching is then considered more satisfactory.

As for f^{(m,0)}, which is to be initially determined, a coarser level by one may be referred to since there is no other submapping at the same level to be referred to as shown in the equation (19). In this base technology, however, a procedure is adopted such that after the submappings were obtained up to f^{(m,3)}, f^{(m,0)} is recalculated once utilizing the thus obtained subamppings as a constraint. This procedure is equivalent to a process in which s=4 is substituted into the equation (20) and f^{(m,4)} is set to f^{(m,0)} anew. The above process is employed to avoid the tendency in which the degree of association between f^{(m,0)} and f^{(m,3)} becomes too low. This scheme actually produced a preferable result. In addition to this scheme, the submappings are shuffled in the experiment as described in [1.7.1], so as to closely maintain the degrees of association among submappings which are originally determined independently for each type of critical point. Furthermore, in order to prevent the tendency of being dependent on the starting point in the process, the location thereof is changed according to the value of s as described in [1.7].

FIG. 13 illustrates how the submapping is determined at the 0-th level. Since at the 0-th level each sub-image is consitituted by a single pixel, the four submappings f^{(0,s)} are automatically chosen as the identity mapping. FIG. 14 shows how the submappings are determined at the first level. At the first level, each of the sub-images is constituted of four pixels, which are indicated by solid lines. When a corresponding point (pixel) of the point (pixel)×in p^{(1,s)} is searched within q^{(1,s)}, the following procedure is adopted:

1. An upper left point a, an upper right point b, a lower left point c and a lower right point d with respect to the point x are obtained at the first level of resolution.

2. Pixels to which the points a to d belong at a coarser level by one, i.e., the 0-th level, are searched. In FIG. 14, the points a to d belong to the pixels A to D, respectively. However, the pixels A to C are virtual pixels which do not exist in reality.

3. The corresponding points A′ to D′ of the pixels A to D, which have already been defined at the O-th level, are plotted in q^{(1,s)}. The pixels A′ to C′ are virtual pixels and regarded to be located at the same positions as the pixels A to C.

4. The corresponding point a′ to the point a in the pixel A is regarded as being located inside the pixel A′, and the point a′ is plotted. Then, it is assumed that the position occupied by the point a in the pixel A (in this case, positioned at the lower right) is the same as the position occupied by the point a′ in the pixel A′.

5. The corresponding points b′ to d′ are plotted by using the same method as the above 4 so as to produce an inherited quadrilateral defined by the points a′ to d′.

6. The corresponding point x′ of the point x is searched such that the energy becomes minimum in the inherited quadrilateral. Candidate corresponding points x′ may be limited to the pixels, for instance, whose centers are included in the inherited quadrilateral. In the case shown in FIG. 14, the four pixels all become candidates.

The above described is a procedure for determining the corresponding point of a given point x. The same processing is performed on all other points so as to determine the submappings. As the inherited quadrilateral is expected to become deformed at the upper levels (higher than the second level), the pixels A′ to D′ will be positioned apart from one another as shown in FIG. 3.

Once the four submappings at the m-th level are determined in this manner, m is incremented (S22 in FIG. 12). Then, when it is confirmed that m does not exceed n (S23), return to S21. Thereafter, every time the process returns to S21, submappings at a finer level of resolution are obtained until the process finally returns to S21 at which time the mapping f⁽ⁿ⁾ at the n-th level is determined. This mapping is denoted as f⁽ⁿ⁾(η=0) because it has been determined relative to η=0.

Next, to obtain the mapping with respect to other different η, η is shifted by Δη and m is reset to zero (S24). After confirming that new η does not exceed a predetermined search-stop value ηₘₐₓ(S25), the process returns to S21 and the mapping f⁽ⁿ⁾(η=Δη) relative to the new η is obtained. This process is repeated while obtaining f⁽ⁿ⁾(η=iΔη)(i=0,1, . . . ) at S21. When η exceeds ηₘₐₓ, the process proceeds to S26 and the optimal η=ηₒₚₜ is determined using a method described later, so as to let f⁽ⁿ⁾(η=ηₒₚₜ) be the final mapping f⁽ⁿ⁾.

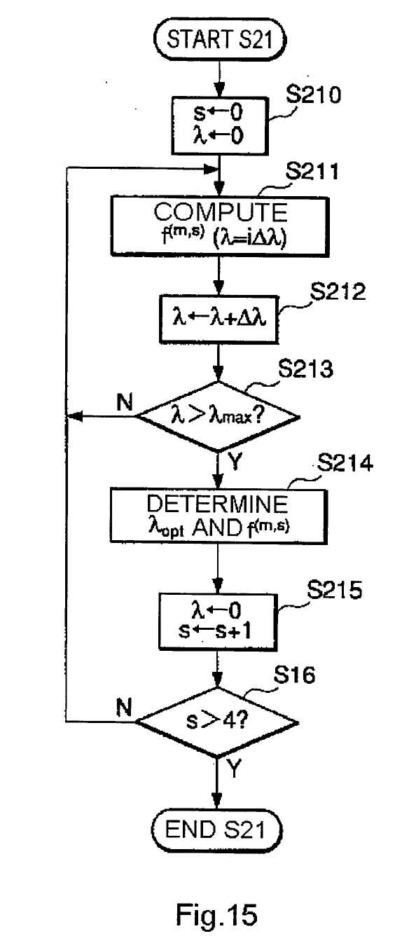

FIG. 15 is a flowchart showing the details of the process of S21 shown in FIG. 12. According to this flowchart, the submappings at the m-th level are determined for a certain predetermined η. In this base technology, when determining the mappings, the optimal λ is defined independently for each submapping.

Referring to FIG. 15, s and λ are first reset to zero (S210). Then, obtained is the submapping f^{(m,s)} that minimizes the energy with respect to the then λ (and, implicitly, η) (S211), and the thus obtained submapping is denoted as f^{(m,s)}(λ=0). In order to obtain the mapping with respect to other different λ, λ is shifted by Δλ. After confirming that the new λ does not exceed a predetermined search-stop value λₘₐₓ(S213), the process returns to S211 and the mapping f^{(m,s)}(λ=Δλ) relative to the new λ is obtained. This process is repeated while obtaining f^{(m,s)}(λ=iΔλ)(i=0,1, . . . ). When λ exceeds λₘₐₓ, the process proceeds to S214 and the optimal λ=λₒₚₜ is determined, so as to let f⁽ⁿ⁾(λ=λₒₚₜ) be the final mapping f^{(m,s)}(S214).

Next, in order to obtain other submappings at the same level, λ is reset to zero and s is incremented (S215). After confirming that s does not exceed 4(S216), return to S211. When s=4, f^{(m,0)} is renewed utilizing f^{(m,3)} as described above and a submapping at that level is determined.

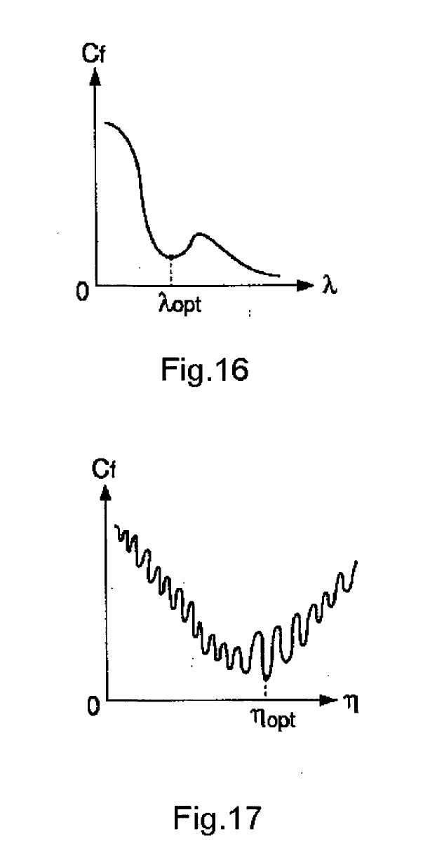

FIG. 16 shows the behavior of the energy C_{f}^{(m,s)} corresponding to f^{(m,s)}(λ=iΔλ)(i=0,1, . . . ) for a certain m and s while varying λ. As described in [1.4], as λ increases, C_{f}^{(m,s)} normally decreases but changes to increase after λ exceeds the optimal value. In this base technology, λ in which C_{f}^{(m,s)} becomes the minima is defined as λₒₚₜ. As observed in FIG. 16, even if C_{f}^{(m,s)} begins to decrease again in the range λ>λₒₚₜ, the mapping will not be as good. For this reason, it suffices to pay attention to the first occurring minima value. In this base technology, λₒₚₜ is independently determined for each submapping including f⁽ⁿ⁾.

FIG. 17 shows the behavior of the energy C_{f}⁽ⁿ⁾ corresponding to f⁽ⁿ⁾(η=iΔη) (i=0,1, . . . ) while varying η. Here too, C_{f}⁽ⁿ⁾ normally decreases as η increases, but C_{f}⁽ⁿ⁾ changes to increase after η exceeds the optimal value. Thus, η in which C_{f}⁽ⁿ⁾ becomes the minima is defined as ηₒₚₜ. FIG. 17 can be considered as an enlarged graph around zero along the horizontal axis shown in FIG. 4. Once ηₒₚₜ is determined, f⁽ⁿ⁾ can be finally determined.

As described above, this base technology provides various merits. First, since there is no need to detect edges, problems in connection with the conventional techniques of the edge detection type are solved. Furthermore, prior knowledge about objects included in an image is not necessitated, thus automatic detection of corresponding points is achieved. Using the critical point filter, it is possible to preserve intensity and locations of critical points even at a coarse level of resolution, thus being extremely advantageous when applied to object recognition, characteristic extraction, and image matching. As a result, it is possible to construct an image processing system which significantly reduces manual labor.

Some further extensions to or modifications of the above-described base technology may be made as follows: (1) Parameters are automatically determined when the matching is computed between the source and destination hierarchical images in the base technology. This method can be applied not only to the calculation of the matching between the hierarchical images but also to computing the matching between two images in general.

For instance, an energy E₀ relative to a difference in the intensity of pixels and an energy E₁ relative to a positional displacement of pixels between two images may be used as evaluation equations, and a linear sum of these equations, i.e., Eₜₒₜ=αE₀+E₁, may be used as a combined evaluation equation. While paying attention to the neighborhood of the extrema in this combined evaluation equation, α is automatically determined. Namely, mappings which minimize Eₜₒₜ are obtained for various α's. Among such mappings, α at which Eₜₒₜ takes the minimum value is defined as an optimal parameter. The mapping corresponding to this parameter is finally regarded as the optimal mapping between the two images.

Many other methods are available in the course of setting up evaluation equations. For instance, a term which becomes larger as the evaluation result becomes more favorable, such as 1/E₁ and 1/E₂, may be employed. A combined evaluation equation is not necessarily a linear sum, but an n-powered sum (n=2, ½, −1, −2, etc.), a polynomial or an arbitrary function may be employed when appropriate.

The system may employ a single parameter such as the above α, two parameters such as η and λ as in the base technology, or more than two parameters. When there are more than three parameters used, they may be determined while changing one at a time.

(2) In the base technology, a parameter is determined in a two-step process. That is, in such a manner that a point at which C_{f}^{(m,s)} takes the minima is detected after a mapping such that the value of the combined evaluation equation becomes minimum is determined. However, instead of this two-step processing, a parameter may be effectively determined, as the case may be, in a manner such that the minimum value of a combined evaluation equation becomes minimum. In this case, αE₀+βE₁, for example, may be used as the combined evaluation equation, where α+β=1 may be imposed as a constraint so as to equally treat each evaluation equation. The automatic determination of a parameter is effective when determining the parameter such that the energy becomes minimum.

(3) In the base technology, four types of submappings related to four types of critical points are generated at each level of resolution. However, one, two, or three types among the four types may be selectively used. For instance, if there exists only one bright point in an image, generation of hierarchical images based solely on f^{(m,3)} related to a maxima point can be effective to a certain degree. In this case, no other submapping is necessary at the same level, thus the amount of computation relative on s is effectively reduced.

(4) In the base technology, as the level of resolution of an image advances by one through a critical point filter, the number of pixels becomes 1/4. However, it is possible to suppose that one block consists of 3×3 pixels and critical points are searched in this 3×3 block, then the number of pixels will be 1/9 as the level advances by one.

(5) In the base technology, if the source and the destination images are color images, they would generally first be converted to monochrome images, and the mappings then computed. The source color images may then be transformed by using the mappings thus obtained. However, as an alternate method, the submappings may be computed regarding each RGB component.

Preferred Embodiments Concerning Image Processing

Image processing techniques utilizing the above-described base technology will now be described. Generally speaking, these techniques involve imprinting a corresponding point file and a program used in decoding (hereinafter referred to as a “reproduction program”) into any key frame for later use in generating intermediate images or the like. Since the corresponding point file and reproduction program are “hidden” in the key frames, the key frames seem to be transmitted discretely when a decoding apparatus or the like does not know that the data is imprinted. For example, key frames may be compressed in an intraframe format by JPEG (Joint Photographic Experts Group) standard and sent to a general viewer which can decode JPEG. In this case, only the key frames can be reproduced since the general viewer cannot identify the corresponding point file or reproduction program. On the other hand, a decoding apparatus or viewer which can extract the imprinted corresponding point file and reproduction program, such as described below, can use the reproduction program to generate intermediate frames from the key frames and the corresponding point file and, thus, can reproduce not only the key frames but also the intermediate frames. It is possible, therefore, to provide backward compatibility to exiting technologies and thus promote wider use and acceptance of this new technology.

In a particular example, a user receives an “electronic key” which can be considered a “motion picture reproducing kit” by paying a registration and content fee in order to extract the corresponding point file and the reproduction program. This key extracts the imprinted corresponding point file and reproduction program and executes the program.

Interestingly, because the reproduction program is transmitted every time the key frames are distributed, the reproduction program can be upgraded easily with each distribution.

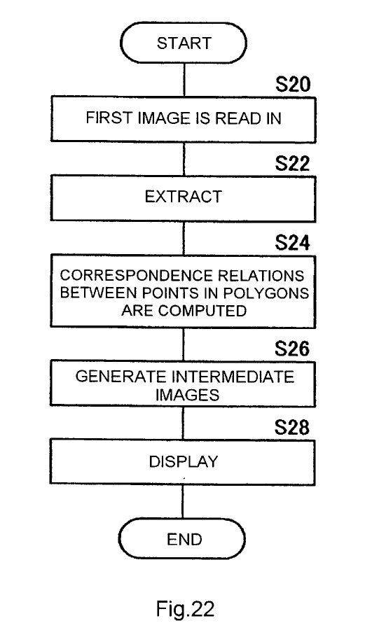

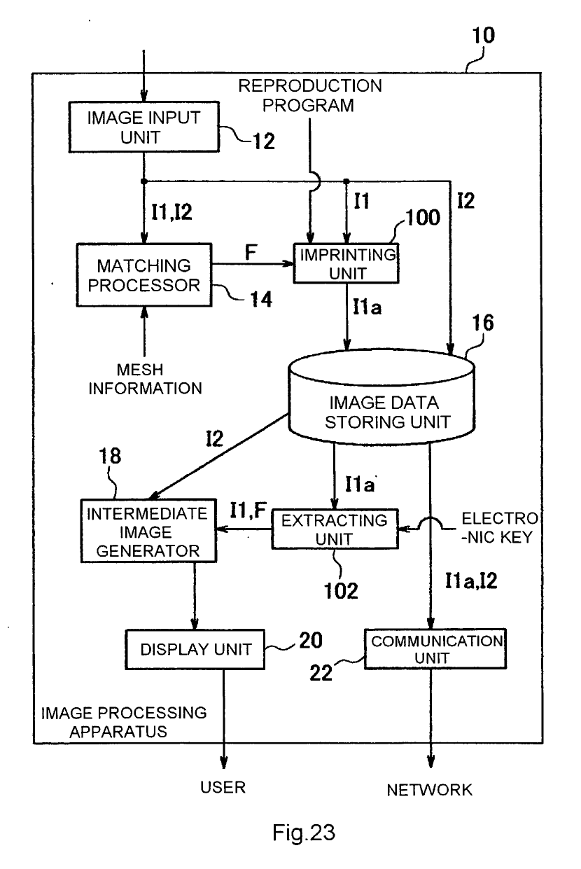

It will be understood that the corresponding point file and the reproduction program must be relatively small in order to be imprinted into the key frames. The reproduction program performs processes as described in relation to FIG. 22 below and it has been confirmed in an experiment that the program can be reduced to a size of at most 100 kilobytes. The corresponding point file, on the other hand, may be fairly large if the corresponding point file describes the detailed pixel-by-pixel correspondence of the base technology. Hereunder, therefore, an effective compression of the corresponding point file using a mesh is first described, following which an image processing apparatus will be described in relation to the FIG. 23.

FIG. 18 shows a first image I1 and a second image I2, which serve as key frames, in which certain pixels p₁(x₁, y₁) and p₂(x₂, y₂) correspond therebetween. The correspondence of the pixels may be obtained using the base technology.

Referring to FIG. 19, a mesh is provided on the first image I1 and corresponding positions of lattice points are shown on the second image I2. In particular, a polygon R1 on the first image I1 is determined by four lattice points A, B, C and D. This polygon R1 is called a “source polygon”. As has been shown in FIG. 18, these lattice points A, B, C and D have respectively corresponding points A′, B′, C′ and D′ on the second image I2, and a polygon R2 formed by the corresponding points is called a “destination polygon.” In this embodiment, the source polygon is generally a rectangle, while the destination polygon is generally a quadrilateral. In any event, according to the present embodiment, the correspondence relation between the first and second images is not described pixel by pixel, instead, corresponding points are described only with respect to the lattice points of the source polygon. This description is then written in a corresponding point file. By directing attention to the lattice points only, the volume of the corresponding point file can be reduced significantly.

As described in the base technology, the corresponding point file is utilized for generating intermediate images between the first image I1 and the second image I2. In particular, intermediate images at arbitrary temporal or spatial positions can be generated by interpolating between the corresponding points. Thus, by using the first image I1, the second image I2 and the corresponding point file it is possible to generate smooth motion pictures or morphing between two images I1 and I2. Thus a compression effect on motion pictures can be obtained by selecting appropriate key frames.

FIG. 20 shows an example method for computing a correspondence relation for points other than the lattice points, from the corresponding point file. Since, in the corresponding point file, there is information on the lattice points only, data corresponding to interior points of each polygon need to be computed separately. FIG. 20 shows correspondence between a triangle ABC (which corresponds to a lower half of the source polygon R1 shown in FIG. 19) and a triangle A′B′C′ (which corresponds to a lower half of the destination polygon R2 shown in FIG. 19). Now, for an interior point Q of triangle ABC, an intersection point of a line segment AC and an extended line of BQ to AC through the interior point Q interior-divides the line segment AC in the ratio t:(1−t) and the point Q interior-divides a line segment connecting such the AC interior-dividing point and point B in the ratio s:(1−s). Similarly, for a corresponding point Q′ in triangle A′B′C′, which corresponds to triangle ABC, an intersection point of a line segment A′C′ and an extended line of B′Q′ to the A′C′ through the corresponding point Q′, which corresponds to the point Q, interior-divides the line segment A′C′, in the ratio t:(1−t) and the point Q′ interior-divides a line segment connecting the A′C′ interior-dividing point and point B′ corresponding to B in the ratio s:(1−s). Namely, it is preferable that the source polygon is divided into a triangle, and interior points of the destination polygon are determined by using interior division of the vectors concerning the triangle. When expressed in a vector skew field, this becomes

BQ=(1−s){(1−t)BA+tBC},

thus, we have

B′Q′=(1−s){(1−t)B′A′+tB′C′}

Similar processing is also performed between a triangle ACD which corresponds to an upper half of the source polygon R1 and a triangle A′C′D′ which likewise corresponds to an upper half of the destination polygon R2.

FIG. 21 shows a flowchart of the encoding procedure described above. Firstly, the matching results on the lattice points taken on the first image I1 are acquired (S10) as shown in FIG. 19. In the matching, it is preferable that the pixel-by-pixel matching according to the base technology is performed, so that a portion corresponding to the lattice points is extracted from those results. It is to be noted that the matching results on the lattice points may alternatively be specified based on other matching techniques, such as optical flow and block matching, instead of using the base technology.

Thereafter, a destination polygon is defined on the second image I2 (S12), as shown in the right side of FIG. 19. The above procedure completes the generation of the corresponding point file. The corresponding point file and the reproduction program are then imprinted into the first image I1. The imprinted or altered first image I1a and the second image I2 may then be output, transmitted, stored, or the like.

An experiment has indicated that high quality intermediate frames with, for example, a resolution of about 256×256 pixels can be acquired from a corresponding point file of approximately some 10s of kilobytes or less when adjusting the size of the corresponding point file appropriate for imprinting in a key frame. The size of the data imprinted, therefore, will be only about 100 kilobytes when the corresponding point file is imprinted together with the reproduction program.

There are various known watermark techniques which can be utilized as a method for imprinting, such as a modulo masking or a density pattern method in which the information of pixel intensity in manipulated or an ordered dither method in which threshold information is manipulated. It will be understood that any appropriate technique may be used for imprinting in this embodiment. It is known, for example, that using the density pattern method, text data of about 70 kilobytes can be incorporated into an image of 256×256 pixels×8 bits without spoiling the optical quality of the image. In addition or alternatively, the imprint of the corresponding point file and the reproduction program can be performed without spoiling the optical quality of the images because they can also be imprinted not only into the first image I1 but also into the second image I2 and any succeeding key frames, though it depends on the actual application of the technology.

FIG. 22 shows a flowchart of a decoding procedure, which is generally performed at a decoding apparatus or the like at the location of a user to whom the motion picture is distributed. Namely, FIG. 22 shows a procedure to generate intermediate images (i.e. a motion picture) by inputting a picture stream comprising the first image I1 and the second image I2 and so forth. As described above, a user may be distributed an electronic key prior to this procedure (not shown in FIG. 22) and is prepared for the procedure with such conditions that it is possible to extract the corresponding point file and the reproduction program.

The first image I1 is first read in (S20), and the corresponding point file and the reproduction program are extracted, in this example, by using the electronic key (S22) at the terminal of the user. Decoding is also performed if the key frame, corresponding point file, or reproduction program are also separately encoded. The methods for extraction of imprinted data are known for each watermark technique respectively, such as modulo masking described above, and an appropriate method may be utilized in this embodiment.

Thereafter, a correspondence relation between points in source polygons and those in destination polygons is computed by a method such as that shown in FIG. 20 (S24). At this time, the correspondence relation for all pixels within each image can be acquired. As described in the base technology, the coordinates and colors of points corresponding to each other can be interior-divided in the ratio u:(1−u), so that an intermediate image in a position which interior-divides, with respect to time for example, in the ratio u:(1−u) between the first image I1 and the second image I2 can be generated (S26).

FIG. 23 shows a structure of an image processing apparatus 10 which performs the above-described procedure. The apparatus 10 comprises an image input unit 12 which acquires the first image I1 and the second image I2 from an external storage device, a photographing camera or the like, a matching processor 14 which performs a matching computation on these images using the base technology or other techniques, an imprinting unit 100 which imprints the corresponding point file F generated by the matching processor 14 and the reproduction program into the first image I1, an image data storing unit 16 which stores the altered first image I1a altered as a result of imprinting (herein referred to as an “altered first image I1a”), the second image I2 and other images, an extracting unit 102 which extracts the corresponding point file F and, by utilizing an electronic key which is separately distributed via a route not shown in FIG. 23, the reproduction program from the altered first image I1a, an intermediate image generator 18 which generates intermediate images between the first image I1 and the second image I2 from the first image I1 (acquired by removing the imprinted data from the altered first image I1a), the second image I2 and the corresponding point file F, and a display unit 20 which displays the first image I1, the second image I2 and the intermediate images as a series of images similar to a motion pictures by adjusting the timing of display. In this apparatus, the reproduction program described above is implemented as the intermediate image generator 18 after being extracted by the extracting unit 102. The functions of the reproduction program may also comprise a part of or the whole of the function of the display unit 20.

Additionally, a communication unit 22 may send out the altered first image I1a, the second image I2 and other images to a transmission infrastructure such as a network or the like according to a request from an external unit.

In FIG. 22, mesh information or data which indicate the size of the mesh, the positions of the lattice points and so forth are provided to the matching processor 14. This mesh information may be preset for various resolution levels, may be input by a user, or the like.

It will be understood that the apparatus 10 described above is a combination of structures for encoding and decoding. It can be simply mentioned that the imprinting unit 100 and antecedent units thereof are the structures for encoding and the extracting unit 102 and succeeding units are the structures for decoding. The image data storing unit 16 is common to both structures and may be provided to both apparatuses if encoding and decoding are respectively performed by separate apparatuses.

By implementing the above-described structure encoding process as follows. The first image I1 and the second image I2 are input in the image input unit 12 and are sent to the matching processor 14. The matching processor 14 performs a pixel-by-pixel matching computation between those images. The matching processor 14 then generates the corresponding point file F based on the mesh data and the thus generated corresponding point file F is output to the imprinting unit 100. The first image I1 is also input in the imprinting unit 100. The imprinting unit 100 imprints the corresponding point file F and also the reproduction program (which is separately provided) into the image I1 and outputs the altered first image I1a to the image data storing unit 16. The image data storing unit 16 also stores the second image I2 and succeeding images. Encoding is completed by the processing described above.

A corresponding point file F which is generated between the second image I2 and a third image 13 may also be imprinted into the second image I2. Thus, the processing may also be recursive. Further, the reproduction program may be divided according to necessity and imprinted into the second image I2 and the succeeding images when the size of the reproduction program is such that the quality of the images are influenced by imprinting solely in the first image I1.

After encoding and distribution or storage in the image data storing unit 18, decoding proceeds as follows. The extracting unit 102 reads out the altered first image I1a from the image data storing unit 16 and extracts the corresponding point file F and the reproduction program by utilizing the electronic key. The extracted corresponding point file F is transmitted to the intermediate image generator 18 and the reproduction program is loaded into a memory (not shown) in an executable format as the entire intermediate image generator 18 or a part thereof.

The intermediate image generator 18 generates the intermediate images between the first image I1 and the second image I2 from the corresponding point file F, the first image I1 (which is acquired by removing the imprinted data from the altered first image I1a) and the second image I2 by performing interpolation. The intermediate images are transmitted to the display unit 20. The timings of outputting the images is adjusted in the display unit 20 such that motion pictures or morphing pictures are displayed. It is to be noted that the first image I1, which is acquired by removing the imprinted data from the altered first image I1a, is not necessarily completely equal to the original first image I1 before imprinting and extracting. A complete correspondence between the original first image I1 and the decoded first image I1 will be realized only if the imprint and extraction are lossless.

The communication unit 22 is provided in consideration of a situation in which the decoding is performed remotely. The communication unit 22 transmits a coded data stream which merely seems to be a series of image frames, such as the altered first image I1a and the second image I2, in appearance. Upon receipt at a remote site, the coded data stream may be either stored or processed for display. A user who has only a viewer for JPEG, for example, and does not have the electronic key to access the reproduction program or corresponding point file can still reproduce the key frames frame by frame when the altered first image I1a and other images are described in a JPEG format. This structure encourages a user who wants to enjoy the complete content as motion pictures to acquire the electronic key and a business model can be promoted in which the electronic keys are distributed after paying a fee.

It will be understood that there are many variations and alternate arrangements of the procedures and apparatus described above. Several variations are now described.

Although encoding and decoding of the motion pictures are considered in the above-described embodiments of the present invention, it is not necessary that the interpolation be performed temporally. Spatial interpolation between multi viewpoint images can also be performed and used in a similar way.

The first image I1 and other images may be compressed by arbitrary image compression methods including JPEG described above. In these cases, the compression may be performed separately from that encoding described, that is, incorporation of the information of the corresponding point into the images. With regard to decoding, it is sufficient if decompression and the described interpolation of the images are performed, respectively.

Although the embodiments above involve images, the present invention can also be applied generally to other forms of digital content. It is sufficient if the digital content is acquired and a program for reproducing or decoding the content, that is a reproduction program, is imprinted into the content. As particular examples, this content may have:

1) particularity in relationship to the reproduction program such that the entire content can be reproduced by utilizing the program, though the content is stored in a generalized format in which it is possible to partly reproduce the content without the reproduction program; or

2) particularity in relationship to the reproduction program such that the content can be reproduced with high quality by utilizing the reproduction program, though the content is stored in a generalized format in which it is possible to reproduce the content with low quality without the reproduction program.

These variations can be derived from the description above by considering that at least key frames can be reproduced without the specific reproduction program when reproducing motion pictures according to the preferred embodiment described above. Further, it is also to consider a situation in which the reproduction program is imprinted into motion picture data which normally can be reproduced for one minute so that a longer motion picture, for example 10 minutes, might be reproduced with the reproduction program. Similarly a reproduction program which can reproduce an entire music album may be imprinted into data which is stored in a manner that only a simple song can be reproduced by MP3 or another format.

Similar processing can be considered for both image quality and sound quality. Original data, for example, can normally be reproduced only in a thinned out or lower quality manner, and a program for reproducing expanded or the entire data may be imprinted into the data.

According to the above-described embodiments, an electronic key is distributed to a user via a route or at a timing which is separate from that of the distribution of the image data. This key may be, however, distributed to the user being imprinted into the images. Alternatively, the reproduction program itself may be previously distributed to the user. For example, the reproduction program may be structured in such a manner that it is downloaded with no charge of money. A method may comprise: acquiring images; and imprinting data utilized for image processing into the images, similar to the embodiments described above. The above-described “data utilized for image processing” corresponds to an electronic key.

Further variations, alterations or features are defined in the following references:

7. An image processing method, comprising: acquiring a first image and a second image; computing a matching between the acquired first and second images; and imprinting information of corresponding points acquired as a result of the matching into at least one of the first and second images.

8. An image processing method, comprising: acquiring a first image and a second image; computing a matching between the acquired first and second images; and imprinting information of corresponding points acquired as a result of the matching into an image which is comprised in a motion picture stream which comprises the first and second images.

9. An image processing apparatus, comprising: an image input unit which acquires images and an imprinting unit which imprints data utilized for processing the images into the images.

10. An apparatus according to reference 9, wherein the imprinting unit imprints data regarding interpolation of the images.

11. An apparatus according to reference 9, wherein the imprinting unit imprints information of corresponding points between at least selected images of the images and other images.

12. An image processing apparatus, comprising: an image input unit which acquires images, and an imprinting unit which imprints data utilized for decoding the images thereinto.

13. An apparatus according to reference 12, wherein the imprinting unit imprints data regarding interpolation of the images.

14. An apparatus according to reference 12, wherein the imprinting unit imprints information of corresponding points between the images and other images.

15. An image processing apparatus, comprising: an input unit which acquires a first image and a second image; a matching processor which computes a matching between the acquired first and second images; and an imprinting unit which imprints information of corresponding points acquired as a result of the matching into at least one of the first and second images.

16. An image processing apparatus, comprising: an input unit which acquires a, first image and a second image; a matching processor which computes a matching between the acquired first and second images; and an imprinting unit which imprints information of corresponding points acquired as a result of the matching into an image comprised in a motion picture stream which comprises the first and second images.

17. An apparatus according to reference 15 or 16, wherein the matching processor performs a pixel-by-pixel matching computation based on correspondence between a critical point detected through a two-dimensional search on the first image and a critical point detected through a two-dimensional search on the second image.

18. An apparatus according to reference 17, wherein the matching processor multiresolutionalizes the first image and the second image by respectively extracting the critical points, then performs the pixel-by-pixel matching computation between same multiresolution levels, and acquires a pixel-by-pixel correspondence relation at a finest level of resolution while inheriting a result of the pixel-by-pixel matching computation from a matching computation at a different multiresolution level.

27. An image processing apparatus, comprising: an image input unit which acquires images; and an extracting unit which extracts data imprinted into the acquired images therefrom, which are utilized for performing processing thereon.

28. An apparatus according to reference 27, wherein the extracting unit extracts data regarding interpolation of the images.

29. An apparatus according to reference 27, wherein the extracting unit extracts information of corresponding points between the images and other images.

30. An apparatus according to one of the references 27, 28, or 29, further comprising: an intermediate image generator which performs interpolation of the images based on the extracted data; and an output unit which outputs motion pictures acquired as a result of the interpolation.

31. An image processing apparatus, comprising: an image input unit which acquires images; and an extracting unit which extracts data imprinted into the acquired images therefrom, which are utilized for decoding the images.

32. An apparatus according to reference 31, wherein the extracting unit extracts data regarding interpolation of the images.

33. An apparatus according to reference 31, wherein the extracting unit extracts information of corresponding points between the images and other images.

34. An apparatus according to one of the references 31, 32, or 34, further comprising: an intermediate image generator which performs interpolation of the images based on the extracted data; and an output unit which outputs motion pictures acquired as a result of the interpolation.

35. An image processing method, comprising: acquiring a first image and a second image as key frames, which are respectively a predetermined distance from each other; computing a matching between the acquired first and second images; compressing the first image and the second image in an intraframe format; imprinting information of corresponding points acquired as a result of the matching into at least one of the compressed first and second images; generating a coded motion picture stream which comprises at least the compressed first and second images as the key frames after imprinting; and outputting the generated coded motion picture stream.

36. An image processing method, comprising: acquiring a first image and a second image as key frames, which respectively keep predetermined distance to each other; computing a matching between the acquired first and second images; compressing the first image and the second image in an intraframe format; imprinting information of corresponding points acquired as a result of the matching into a predetermined image in a coded motion picture stream which comprises the compressed first and second images; generating the coded motion picture stream which comprises at least the compressed first and second images and the prescribed image as the key frames after imprinting; and outputting the generated coded motion picture stream.

37. A computer program executable by a computer, the program comprising the functions of: acquiring images; and imprinting data utilized for processing into the images, which are performed thereon.

38. A computer program executable by a computer, the program comprising the functions of: acquiring images; and imprinting data utilized for decoding the images thereinto.

39. A computer program executable by a computer, the program comprising the functions of: acquiring images; and extracting data imprinted into the acquired images therefrom, which are utilized for performing processing thereon.

40. A computer program executable by a computer, the program comprising the functions of: acquiring images; and extracting data imprinted into the images therefrom, which are utilized for decoding the images.

41. A computer program executable by a computer according to reference 39 or 40, further comprising the function of acquiring an electronic key utilized for extracting the data.

43. A method according to reference 7, further comprising distributing an electronic key for extracting the information of the corresponding points to a user.

45. A method according to reference 35, further comprising distributing an electronic key for extracting the imprinted information of the corresponding points to a user.

46. An image processing method, comprising: acquiring images; and imprinting a program for reproducing the images thereinto.

47. An image processing method, comprising: acquiring images; and imprinting a program for decoding the images thereinto.

48. A method according to one of the references 46 or 47, wherein the images comprise discrete image frames and the program converts the image frames into continuous motion pictures.

49. A method according to one of the references 46 or 47, wherein the program performs interpolation processing on the images.

50. A method according to reference 49, wherein the interpolation processing is processing which generates an intermediate frame between a plurality of key frames based on information of corresponding points between the key frames.

51. A method according to reference 50, wherein the information of the corresponding points is also imprinted into the images in addition to the program.

52. A method according to one of the references 46 or 47, further comprising distributing an electronic key for extracting the program to a user.

53. An image processing method, comprising: acquiring a first image and a second image; computing a matching between the acquired first and second images; imprinting information of corresponding points acquired as a result of the matching into at least one of the first and second images; and imprinting a program for generating an intermediate image of the first image and the second image based on the imprinted information of the corresponding points into at least one of the first and second images.

54. An image processing method, comprising: acquiring a first image and a second image; computing a matching between the acquired first and second images; imprinting information of corresponding points acquired as a result of the matching into an image comprised in a motion picture stream which comprises the first image and the second image; and imprinting a program for generating an intermediate image of the first image and the second image based on the imprinted information of the corresponding points into at least one of the first and second images.

55. A method according to reference 53, further comprising distributing an electronic key for extracting the program to a user.

56. An image processing apparatus, comprising: an image input unit which acquires images; and an imprinting unit which imprints a program for reproducing the images thereinto.

57. An image processing apparatus, comprising: an image input unit which acquires images; and an imprinting unit which imprints a program for decoding the images thereinto.

58. An image processing method, comprising: acquiring images; and extracting a program imprinted into the acquired images therefrom, which is utilized for reproducing the images.

59. An image processing method, comprising: acquiring images; and extracting a program imprinted into the acquired images therefrom, which is utilized for decoding the images.

60. A method according to one of the references 58 or 59, further comprising acquiring an electronic key for extracting the program from the images.

61. A method according to one of the references 58 or 59, further comprising extracting information of corresponding points, which is imprinted into the images, in addition to the program.

62. A method according to one of the references 58 or 59, further comprising generating motion pictures based on the images by executing the program.

63. A method according to reference 62, wherein the images comprise a plurality of discrete image frames and the program generates an intermediate frame by interpolating those image frames.

64. An image processing apparatus, comprising: an image input unit which acquires images; and an extracting unit which extracts a program imprinted into the acquired images therefrom, which is utilized for reproducing the images.

65. An image processing apparatus, comprising: an image input unit which acquires images; and an extracting unit which extracts a program imprinted into the acquired images therefrom, which is utilized for decoding the images.

66. An apparatus according to reference 64, wherein the image input unit receives an electronic key which permits to extract or decode the program and processing by the extracting unit is realized by the electronic key.

67. An apparatus according to reference 64, further comprising: n intermediate image generator which performs interpolation of the images by utilizing the extracted program; and an output unit which outputs motion pictures acquired as a result of the interpolation.

68. An image processing method, comprising: acquiring a first image and a second image as key frames, which respectively keep predetermined distance to each other; computing a matching between the acquired first and second images; compressing the first image and the second image in an intraframe format; imprinting a program which generates an intermediate image of the first image and the second image utilizing a result of the matching into at least one of the compressed first and second images; generating a coded motion picture stream which comprises at least the compressed first and second images as the key frames after imprinting; and outputting the coded motion picture stream, which is generated.

69. An image processing method, comprising: acquiring a first image and a second image as key frames, which respectively keep predetermined distance to each other; computing a matching between the acquired first and second images; compressing the first image and the second image in an intraframe format; imprinting a program which generates an intermediate image of the first image and the second image utilizing a result of the matching into a predetermined image in a coded motion picture stream which comprises the compressed first and second images; generating the coded motion picture stream which comprises at least the compressed first and second images and the predetermined image as the key frames after imprinting; and outputting the coded motion picture stream, which is generated.

70. A computer program executable by a computer, the program comprising the functions of: acquiring images; and imprinting a program for reproducing the images thereinto.

71. A computer program executable by a computer, the program comprising the functions of: acquiring images; and imprinting a program for decoding the images thereinto.

72. A computer program executable by a computer, the program comprising the functions of: acquiring images; and extracting a program imprinted into the acquired images therefrom, which is utilized for reproducing the images.

73. A computer program executable by a computer, the program comprising the functions of: acquiring images; and extracting a program imprinted into the acquired images threrefrom, which is utilized for decoding the images.

74. A content storing method, comprising: acquiring a content in a digital format; and imprinting a program for reproducing or decoding the content thereinto.

75. A method according to reference number 74, wherein the content is provided with particularity in relationship to the program that the entire content can be reproduced by utilizing the program, though the content is stored in a generalized format in which the content can be partly reproduced without the program.

76. A method according to reference number 74, wherein the content is provided with particularity in relationship to the program that the content can be reproduced with high quality, though the content is stored in a generalized format in which the content can be reproduced with low quality without the program.

What is claimed is:

1. An image processing method comprising:
acquiring images; and
imprinting data utilized for processing the images into the images.

2. A method according to claim 1, wherein the data comprise data regarding interpolation of the images.

3. A method according to claim 1, wherein the data comprise information of corresponding points between at least selected images of the images.

4. A method according to claim 1, further comprising distributing an electronic key for extracting the data.

5. An image processing method comprising:
acquiring images; and
imprinting data utilized for decoding the images into the images.

6. A method according to claim 5, wherein the data comprise data regarding interpolation of the images.

7. A method according to claim 5, wherein the data comprise information of corresponding points between at least selected images of the images and other images.

8. A method according to claim 5, further comprising distributing, to a user, an electronic key for extracting the data.

9. An image processing method comprising:
acquiring images; and
extracting data imprinted into the acquired images therefrom and utilizing the extracted data for processing the acquired images.

10. A method according to claim 9, wherein the data comprise data regarding interpolation of the images.

11. A method according to claim 9, wherein the data comprise information of corresponding points between the images and other images.

12. A method according to claim 9, wherein the processing comprises performing interpolation of the images based on the data; and further comprising:
outputting motion pictures generated as a result of the interpolation.

13. A method according to claim 9, further comprising acquiring an electronic key for permitting extraction prior to extracting the data.

14. A method according to claim 10, wherein the processing comprises performing interpolation of the images based on the data; and further comprising:
outputting motion pictures generated as a result of the interpolation.

15. A method according to claim 11, wherein the processing comprises performing the interpolation of the images based on the data; and further comprising:
outputting motion pictures generated as a result of the interpolation.

16. An image processing method, comprising:
acquiring images; and
extracting data imprinted into the acquired images therefrom and utilizing the extracted data for decoding the images.

17. A method according to claim 16, wherein the data comprise data regarding interpolation of the images.

18. A method according to claim 16, wherein the data comprise information of corresponding points between the images and other images.

19. A method according to claim 16, wherein the decoding comprises performing the interpolation of the images based on the data; and further comprising:
outputting motion pictures acquired as a result of the interpolation.

20. A method according to claim 16, further comprising acquiring an electronic key for permitting extraction prior to extracting the data.

21. A method according to claim 17, wherein the decoding comprises performing the interpolation of the images based on the data; and further comprising:
outputting motion pictures acquired as a result of the interpolation.

22. A method according to claim 18, wherein the decoding comprises performing the interpolation of the images based on the data; and further comprising:
outputting motion pictures acquired as a result of the interpolation.
